(19) United States
(12) Patent Application Publication
(10) Pub. No.: US 2015/0220266 A1
(43) Pub. Date: Aug. 6, 2015

(54) INFORMATION PROCESSING TERMINAL APPARATUS CONTROLLING DISPLAY DEVICE TO DISPLAY WINDOW IN RELATIONSHIP TO PERIPHERAL EQUIPMENT

(71) Applicant: Panasonic Corporation, Osaka (JP)

(72) Inventors: Takashi Morimoto, Osaka (JP); Takeshi Nakayama, Hyogo (JP); Masahiro Ishii, Hyogo (JP); Kouji Kai, Fukuoka (JP)

(21) Appl. No.: 14/346,108

(22) PCT Filed: Aug. 28, 2013
(86) PCT No.: PCT/JP2013/005084

§ 371 Date: Mar. 20, 2014

(30) Foreign Application Priority Data
Nov. 6, 2012 (JP) 2012-244622

(51) Int. Cl. G06F 3/0488; G06F 3/0486; G06F 3/0484; G09G 3/36; G06F 3/0481

(52) U.S. Cl. CPC G06F 3/04886; G09G 3/36; G06F 3/04817; G06F 3/04842; G06F 3/0486; G06F 3/04883; G06F 2203/04101; G06F 2203/04808; G09G 2354/00; G09G 2340/02; G09G 2340/0492; G09G 2370/16

(57) ABSTRACT

A first recording medium is wirelessly connected to an information processing terminal apparatus via an antenna of the first recording medium and an first antenna of the information processing terminal apparatus. A second recording medium is wirelessly connected to the information processing terminal apparatus via an antenna of the second recording medium and a second antenna of the information processing terminal apparatus. A popup window indicating no data in the first recording medium is displayed from a position to be close to the first antenna of the information processing terminal apparatus of a connection position to the first recording medium, and a popup window indicating a list of data within the second recording medium is displayed from a position to be close to the second antenna of the information processing terminal apparatus of a connection position to the second recording medium.

### TECHNICAL FIELD

The present disclosure relates to an information processing terminal apparatus such as a tablet terminal and a control method therefor, and to a program including each step of the control method.

### BACKGROUND

In recent years, a portable information processing terminal apparatus represented by a tablet terminal and a smartphone has been widely used. Users of the portable information processing terminal apparatus have strongly required miniaturizing and thinning the information processing terminal apparatus, and improving the waterproof property and the designability of the information processing terminal apparatus. As a result, the information processing terminal apparatus substantially has only a display in appearance. Therefore, the users operate the information processing terminal apparatus by touching on a touch panel on this display.

When performing data communication between such an information processing terminal apparatus and peripheral equipment, the users often use a graphical user interface such as an icon of the peripheral equipment displayed on the display of the information processing terminal apparatus. For example, when the peripheral equipment of a recording medium is wiredly or wirelessly connected to the information processing terminal apparatus, a pictorial icon representing the recording medium is displayed on the display, and the users output data to the peripheral equipment by dragging and dropping an icon representing the data in the information processing terminal apparatus to the icon representing the peripheral equipment. As described above, when the peripheral equipment is the recording medium, the users can output the data to the recording medium by an intuitive and easily understandable operation.

However, for example, when the peripheral equipment is a projector apparatus, an icon corresponding to the projector apparatus is not generally displayed on the display of the information processing terminal apparatus, and therefore, the users can not intuitively operate the projector apparatus by using the information processing terminal apparatus. In addition, when two recording media are simultaneously connected to the information processing terminal apparatus, two identical icons are generally displayed on the display of the information processing terminal apparatus, and therefore, they are indistinguishable.

A new interface like a tangible user interface that uses a physical tile or tag is proposed (See PATENT LITERATURES 1 and 2) besides the graphical user interface that uses icons displayed on the display together with an input device such as a mouse pointer or a touch panel. For example, a method of operating the information processing terminal apparatus by arranging a plurality of tiles on the display of the information processing terminal apparatus is described in PATENT LITERATURE 1. For example, a tile representing a printer is placed on the display, a tile representing image data is placed adjacent to the tile, and the image data is printed by the printer when the users move the tile representing the image data to the tile representing the printer. As described above, the tangible user interface of the combination of the graphical user interface and the physical tag or tile has such an advantage that it can be operated more intuitively than the graphical user interface of the prior art.

### CITATION LIST

### Patent Literature

PATENT LITERATURE 1: Japanese Patent Laid-open Publication No. JP2002-132446 A

PATENT LITERATURE 2: Japanese Patent Laid-open Publication No. JP2007-26121 A

### SUMMARY OF THE INVENTION

### Technical Problem

Since the peripheral equipment is displayed as a virtual icon on the display in the case of the graphical user interface as described above, the users need to perform operation by replacing in their heads the peripheral equipment connected to the information processing terminal apparatus with the icon on the display. In addition, in the case of the tangible user interface as described in PATENT LITERATURES 1, the peripheral equipment corresponds to a physical tag or tile, and therefore, the users need to perform operation by replacing in their heads the peripheral equipment with the physical tag or tile. As described above, conventionally, the users has needed to correspond an actual peripheral equipment to a virtual icon, a physical tag or tile on the screen. Therefore, the operability of the information processing terminal apparatus has occasionally been deteriorated.

An object of the present disclosure is to solve the above-described problems, and to provide an information processing terminal apparatus capable of operating the peripheral equipment connected thereto more intuitively than that of the prior art, a control method therefor, and a program including respective steps of the control method.

### Solution to Problem

According to one aspect of the present disclosure, there is provided an information processing terminal apparatus including displaying means configured to display predetermined information, and control means configured to control the displaying means to display a window displaying in relationship to the peripheral equipment on the displaying means when peripheral equipment is connected to a predetermined connection position of the information processing terminal apparatus.

It is noted that these comprehensive and specific aspects may be implemented by systems, methods, and computer programs, and arbitrary combinations thereof.

### Advantageous Effects of the Invention

According to the above-described configuration, when peripheral equipment is connected to a predetermined connection position to the information processing terminal apparatus, a popup balloon window displaying a popup balloon is displayed on the displaying means from the connection position to the displaying means or a position in the proximity of the connection position. Therefore, the users can operate the peripheral equipment connected to the information processing terminal apparatus more intuitively than that of the prior art.

### BRIEF DESCRIPTION OF DRAWINGS

FIG. 1 is a plan diagram showing an information processing terminal apparatus 1 according to a first embodiment of the present disclosure, and recording media 2A and 2B.

FIG. 2 is a block diagram showing respective configurations of the information processing terminal apparatus 1 of FIG. 1 and the recording media 2A and 2B.

FIG. 3 is a partially cross sectional view cutting across an antenna A1 of FIG. 1.

FIG. 4 is a flow chart showing a popup balloon window displaying process executed by a main processor 11 of FIG. 2.

FIG. 5 is a plan diagram showing a first example of popup balloon windows 200A and 200B displayed on a liquid crystal panel 31 when the recording media 2A and 2B are wirelessly connected to the information processing terminal apparatus 1 of FIG. 1.

FIG. 6 is a plan diagram showing a second example of the popup balloon windows 200A and 200B displayed on the liquid crystal panel 31 when the recording media 2A and 2B are wirelessly connected to the information processing terminal apparatus 1 of FIG. 1.

FIG. 7 is a plan diagram showing a third example of the popup balloon windows 200A and 200B displayed on the liquid crystal panel 31 when the recording media 2A and 2B are wirelessly connected to the information processing terminal apparatus 1 of FIG. 1.

FIG. 8 is a plan diagram showing a fourth example of the popup balloon windows 200A and 200B displayed on the liquid crystal panel 31 when the recording media 2A and 2B are wirelessly connected to the information processing terminal apparatus 1 of FIG. 1.

FIG. 9 is a plan diagram showing a popup balloon window 200C displayed on the liquid crystal panel 31 when a camera 2C is wirelessly connected to the information processing terminal apparatus 1 of FIG. 1.

FIG. 10 is a plan diagram showing a popup balloon window 200D displayed on the liquid crystal panel 31 when a camera 2D is wirelessly connected to the information processing terminal apparatus 1 of FIG. 1.

FIG. 11 is a plan diagram showing a popup balloon window 200E displayed on the liquid crystal panel 31 when a speaker 2E is wirelessly connected to the information processing terminal apparatus 1 of FIG. 1.

FIG. 12 is a plan diagram showing a popup balloon window 200F displayed on the liquid crystal panel 31 when a keyboard 2F is wirelessly connected to the information processing terminal apparatus 1 of FIG. 1.

FIG. 13 is a plan diagram showing popup balloon windows 200G and 200H displayed on the liquid crystal panel 31 when an HDMI (registered trademark) connector 2G and a DSUB connector 2H are wirelessly connected to the information processing terminal apparatus 1 of FIG. 1.

FIG. 14 is a plan diagram showing a user's flick operation when data within the information processing terminal apparatus 1 is output from the HDMI (registered trademark) connector 2G in FIG. 13.

FIG. 15 is a plan diagram showing a popup balloon window 200I displayed on the liquid crystal panel 31 when a wireless LAN adapter 2I is wirelessly connected to the information processing terminal apparatus 1 of FIG. 1.

FIG. 16 is a plan diagram showing a popup balloon window 200J displayed on the liquid crystal panel 31 when a printer 2J is wirelessly connected to the information processing terminal apparatus 1 of FIG. 1.

FIG. 17 is a plan diagram showing a method for detecting the connection position to the recording medium 2B by the information processing terminal apparatus 1 according to a modified embodiment of the first embodiment of the present disclosure.

FIG. 18 is a flow chart showing a data copy process executed by the main processor 11 of FIG. 2 according to a second embodiment of the present disclosure.

FIG. 19 is a plan diagram showing one example of the popup balloon window 200A displayed on the liquid crystal panel 31 in step S14 of FIG. 18.

FIG. 20 is a plan diagram showing one example of the popup balloon window 200B displayed on the liquid crystal panel 31 in step S19 of FIG. 18.

FIG. 21 is a plan diagram showing one example of a text message 201 displayed on the liquid crystal panel 31 in step S21 of FIG. 18.

FIG. 22 is a flow chart showing a data copy process executed by the main processor 11 of FIG. 2 according to a third embodiment of the present disclosure.

FIG. 23 is a plan diagram showing one example of a text message 202 and buttons 203 and 204 displayed on the liquid crystal panel 31 in step S31 of FIG. 22.

FIG. 24 is a plan diagram showing another example of the text message 202, and the buttons 203 and 204 displayed on the liquid crystal panel 31 in step S31 of FIG. 22.

FIG. 25 is a flow chart showing a data copy process executed by the main processor 11 of FIG. 2 according to a fourth embodiment of the present disclosure.

FIG. 26 is a plan diagram showing one example of a popup balloon window 301 and an arrow 302 displayed on the liquid crystal panel 31 in step S40 of FIG. 25.

FIG. 27A is a plan diagram showing a further popup method for displaying the popup balloon window 200B such as FIG. 5.

FIG. 27B is a plan diagram showing a further popup method for displaying the popup balloon window 200B such as FIG. 5.

FIG. 27C is a plan diagram showing a further popup method for displaying the popup balloon window 200B such as FIG. 5.

FIG. 27D is a plan diagram showing a further popup method for displaying the popup balloon window 200B such as FIG. 5.

FIG. 27E is a plan diagram showing a further popup method for displaying the popup balloon window 200B such as FIG. 5.

FIG. 27F is a plan diagram showing a further popup method for displaying the popup balloon window 200B such as FIG. 5.

FIG. 28A is a plan diagram for explaining the “proximity” when the popup balloon window 200B such as FIG. 5 is displayed from a position in the proximity of the connection position to the recording media 2B.

FIG. 28B is a plan diagram showing an example in which the popup balloon window 200B of FIG. 28A pops up from a position other than the position in the proximity of the connection position to the recording medium 2B.

FIG. 29A is a plan diagram for explaining a position where the popup balloon window 200A of FIG. 5 pops up.

FIG. 29B is a plan diagram for explaining a position where the popup balloon window 200A of FIG. 5 pops up.

FIG. 29C is a plan diagram for explaining a position where the popup balloon window 200A of FIG. 5 pops up.

### DESCRIPTION OF EMBODIMENTS

Embodiments of the present disclosure will be described below with reference to the drawings. It is noted that like components are denoted by the same reference signs.

### First Embodiment

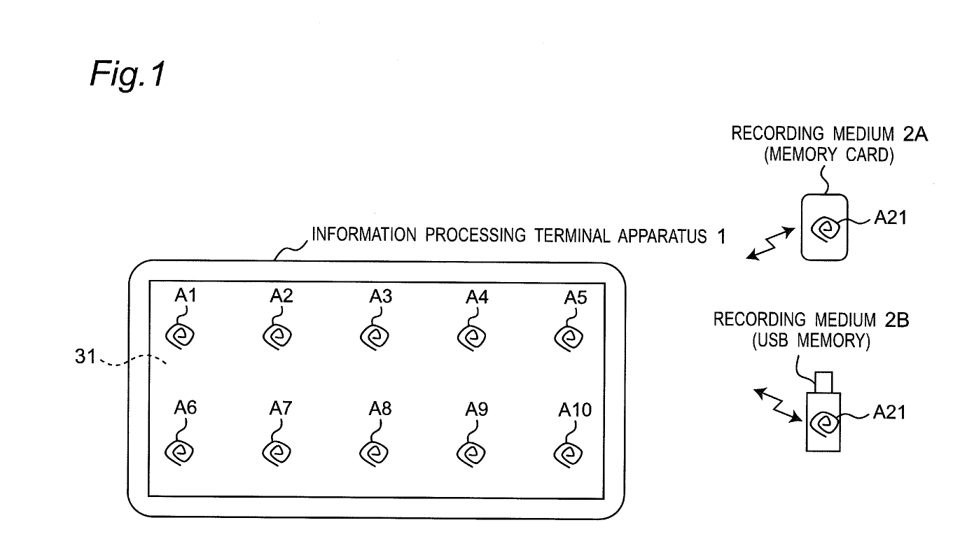

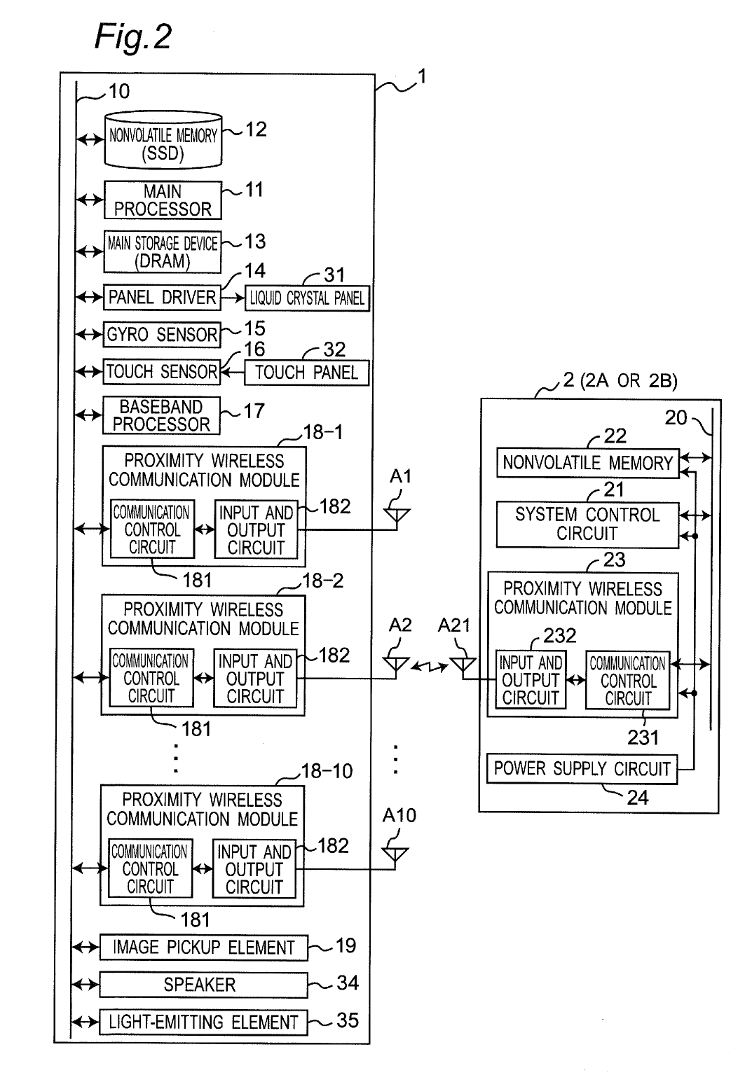

FIG. 1 is a plan diagram showing the information processing terminal apparatus 1 of the first embodiment of the present disclosure and recording media (peripheral equipment) 2A and 2B, and FIG. 2 is a block diagram showing respective configurations of the information processing terminal apparatus 1 and the recording media 2A and 2B of FIG. 1. Referring to FIG. 1, the information processing terminal apparatus 1 of the present embodiment is, for example, a tablet terminal, the recording medium 2A is, for example, a memory card, and the recording medium 2B is, for example, a USB (Universal Serial Bus) memory. As described below in detail, the recording media 2A and 2B are wirelessly connected to the information processing terminal apparatus 1, respectively. It is noted that the recording medium 2A has the same configuration as that of the recording medium 2B, and therefore, the recording media 2A and 2B are described as the recording media 2 in the following descriptions when it is not necessary to distinguish the recording medium 2A from the recording medium 2B.

Referring to FIG. 2, the information processing terminal apparatus 1 is configured to include a main processor (control means) 11 of a CPU (Central Processing Unit), an SSD (Solid State Drive) 12 of a nonvolatile memory, a main storage device 13 of a DRAM (Dynamic Random Access Memory), a liquid crystal panel (displaying means) 31, a panel driver 14 for driving the liquid crystal panel 31, a gyro sensor 15, a touch panel 32, a touch sensor 16 for detecting a touch position at the touch panel 32, a baseband processor 17, proximity wireless communication modules 18-1 to 18-10, an image pickup element 19, a speaker 34, a light-emitting element 35, a bus 10, and antenna coils for transmitting and receiving (each referred to as antenna hereinafter) A1 to A10. In addition, the proximity wireless communication modules 18-n (n=1, 2, . . . , 10) are configured to include communication control circuits 181, and input and output circuits 182 for driving the antennas An (n=1, 2, . . . , 10).

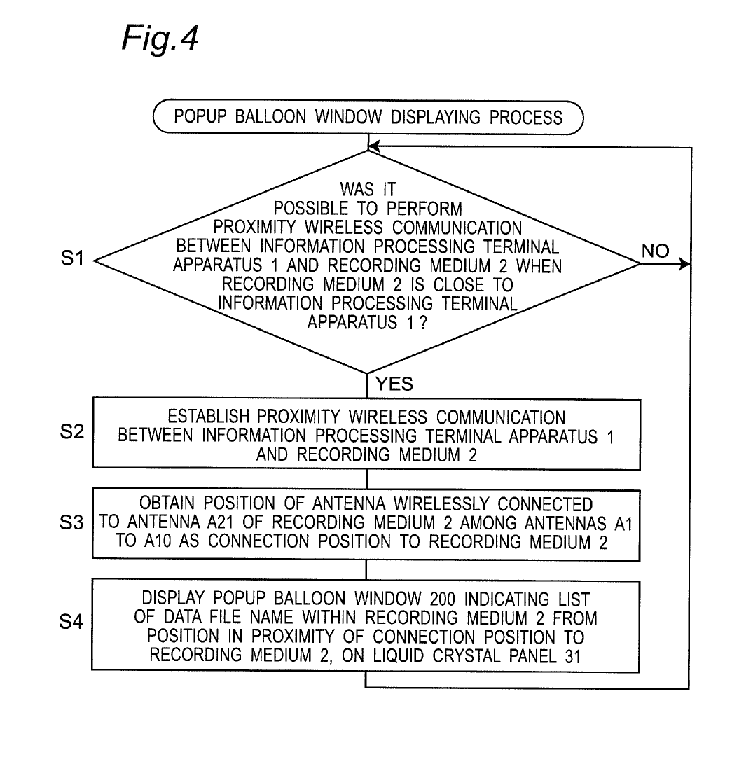

Referring to FIG. 2, the main processor 11 is connected to each of the parts 12 to 17, 18-1 to 18-10, 19, 34 and 35 of the other hardware via a bus 10, and controls them. In addition, the main processor 11 executes various kinds of functions of software. The nonvolatile memory 12 stores in advance various kinds of software programs such as a popup balloon window display process program of FIG. 4, which is necessary for operating the information processing terminal apparatus 1 and executed by the main processor 11. In addition, the main storage device 13 is used as a working area of the main processor 11, and temporarily stores data generated when the program is executed.

In addition, the baseband processor 17 performs a predetermined process such as a communication protocol process for transmission data to be input, and outputs the processed data to the communication control circuit 181 of the proximity wireless communication module selected from the proximity wireless communication modules 18-1 to 18-10 by the main processor 11. In addition, the base band processor 17 extracts received data included in received signals from the communication control circuits 181 of the proximity wireless communication modules 18-1 to 18-10, and outputs the extracted received data to the main processor 11. The communication control circuits 181 of each of the proximity wireless communication modules 18-n (n=1, 2, . . . , 10) performs a predetermined encoding process for the transmission data from the baseband processor 17, modulates a predetermined carrier wave signal to a wireless signal according to the encoded transmission data, and wirelessly transmits from the antennas Tn (n=1, 2, . . . , 10) via the input and output circuits 182. In addition, the communication control circuit 181 of each of the proximity wireless communication modules 18-n (n=1, 2, . . . , 10) decodes the wireless signal received by the antennas Rn (n=1, 2, . . . , 10), serial to parallel-converts the same signals, and outputs the same signals to the baseband processor 17. In addition, the information processing terminal apparatus 1 is further provided with a transmission antenna (not shown), and wirelessly feeds an electric power to the recording media 2 by performing a predetermined wireless feeding process. In addition, in the present embodiment, the carrier wave signal is modulated according to the transmission data. However, the embodiment of the present disclosure is not limited thereto. For example, the carrier wave signal is not modulated, and the transmission data may be directly transmitted.

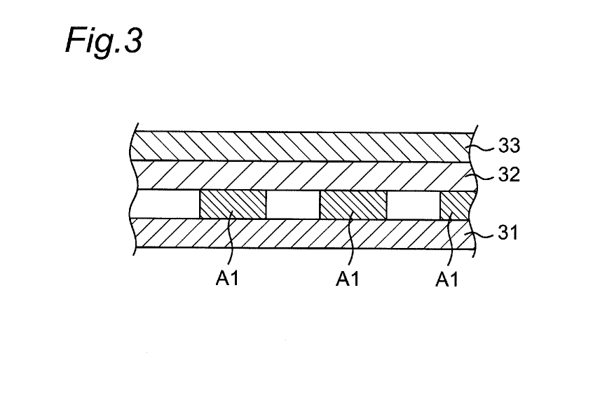

Next, referring to FIGS. 1 and 3, the positions where the antennas A1 to A10 are located are described. FIG. 3 is a partially cross sectional view cutting across the antenna A1 of FIG. 1. As illustrated in FIG. 1, the liquid crystal panel 31 has substantially the same size as that of top surface of the information processing terminal apparatus 1, the ten antennas An (n=1, 2, . . . , 10) are formed at the ten positions on the liquid crystal panel 31, respectively. In this case, the antennas A1 to A10 have the same shape to each other. In addition, as illustrated in FIG. 3, each of the antennas A1 to A10 is formed of a conductive pattern of a transparent conductive film on a front surface of the liquid crystal panel 31 using an indium tin oxide (ITO) or polyethylenedioxythiophene (PEDOT) and the like. Further, the touch panel 32 is provided on each of the antennas A1 to A10, and a protection film 33 of a glass or a resin is formed on the top surface of the touch panel 32.

On the other hand, referring to FIG. 2, the recording media 2 is configured to include a system control circuit 21, a nonvolatile memory 22 of a NAND-type flash memory, a proximity wireless communication module 23, a power supply circuit 24, an antenna A21 of the antenna coil for transmitting and receiving, and a bus 20. In addition, the proximity wireless communication module 23 is configured to include a communication control circuit 231, an input and output circuit 232 for driving the antenna A21.

Referring to FIG. 2, the system control circuit 21 is connected to each of the parts 22 to 24 of the other hardware via the bus 20, and controls them. Further, the system control circuit 21 executes various kinds of functions of software. The nonvolatile memory 22 stores in advance various kinds of software programs, which is necessary for operating the recording media 2 and executed by the system control circuit 21. The power supply circuit 24 is configured to include a power-receiving antenna and a power-receiving circuit, and the power supply circuit 24 receives an electric power from the transmission antenna (not shown) of the information processing terminal apparatus 1 by performing a predetermined wireless feeding process. Then, a capacitor within the power-receiving circuit is charged by the received electric power, and the system control circuit 21, the nonvolatile memory 22, and the proximity wireless communication module 23 are fed from the capacitor.

The communication control circuit 231 performs a predetermined encoding process for the transmission data from the system control circuit 21, modulates a wireless signal according to the encoded transmission data to generate a modulated wireless signal, and wirelessly transmits from the antenna T21 via the input and output circuit 232. In addition, the communication control circuit 231 decodes the wireless signal received by the antenna A21, and serial to parallel converts the same signal and outputs the same signal to the system control circuit 21.

In addition, the antenna A21 has the same shape as those of the antennas A1 to A10. Further, the antenna A21 is located within the recording media 2 so that the antenna A21 is opposed to the antenna A1 to A10, respectively.

Referring to FIG. 1 and each of the following drawings, it is noted that the antenna coils of the antennas A1 to A10 are represented by solid lines, respectively. However, since these antennas are formed of the transparent conductive films, in fact, these antennas can not be seen from a user. In addition, in FIG. 1 and each of the following drawings, the antenna coils of the antennas A21 and A21 are represented by the solid lines, respectively. However, since these antennas are provided inside the peripheral equipment such as the recording media 2, or formed of the transparent conductive films, in fact, these antennas can not be seen from the user.

In the present embodiment, proximity wireless communication is performed between one antenna of the antennas A1 to A10 of the information processing terminal apparatus 1 and the antenna A21 of the recording medium 2. It is necessary for the two antennas to be opposed to each other to perform the proximity wireless communication between the two antennas by utilizing a near electromagnetic field of a short distance equal to or less than a wavelength of an electromagnetic wave. This is because an electric field and a magnetic field drastically become smaller in inverse proportion to a cube of the distance from the antenna. When the antenna A21 is opposed to one antenna of the antennas A1 to A10, these antenna pairs are inductively coupled to each other to form a wireless transmission channel for the proximity wireless communication. At this time, in general, a pair of antennas can realize a data transmission speed more than 1 Gbps. There is such a problem that it is not possible to perform the proximity wireless communication when a pair of antennas is not adjusted so as to be opposed the each other. However, there is such an advantage that it is possible to specify the other communication party only by forming the wireless transmission channel using the opposed antennas, and realize the wireless communication without any interference. Accordingly, the communication system according to the present embodiment can realize a high confidentiality, and is appropriate for the use of a connector.

FIG. 4 is a flow chart showing a popup balloon window displaying process executed by the main processor 11 of FIG. 2. In step S1 of FIG. 4, the main processor 11 judges whether or not it is possible to perform the proximity wireless communication between the information processing terminal apparatus 1 and the recording media 2 when the recording media 2 is close to the information processing terminal apparatus 1. Concretely speaking, the main processor 1 judges that it is possible to perform the proximity wireless communication between the information processing terminal apparatus 1 and the recording media 2 when a communication error rate between the information processing terminal apparatus 1 and the recording medium 2 is equal to or lower than a predetermined threshold value. On the other hand, when the communication error rate is larger than the predetermined threshold value, the main processor 11 judges that it is not possible to perform the proximity wireless communication between the information processing terminal apparatus 1 and the recording media 2. When the user overlaps the recording media 2 on one antenna of the antennas A1 to A10, since the antenna A21 is opposed to the one antenna, then the communication error rate becomes equal or less than the predetermined threshold value. Accordingly, the main processor 11 judges that it is YES in step S1. In step S1, when it is YES, the process proceeds to step S2. On the other hand, if it is NO, the process of step S1 is repeatedly executed.

In step S2, the main processor 11 establishes the proximity wireless communication between the information processing terminal apparatus 1 and the recording medium 2. At this time, the main processor 11 obtains information on the recording medium 2 such as the type of the recording medium 2. Next, in step S3, the main processor 11 obtains the position of the antenna wirelessly connected to the antenna A21, among the antennas A1 to A10, of the recording medium 2 as the connection position to the recording medium 2. Further, in step S4, the main processor 11 displays a popup balloon window 200 popup displaying a list of file names of data in the recording medium 2 on the liquid crystal panel 31 from a position in the proximity of the connection position to the recording medium 2, and the process returns to step S1. That is, the main processor 11 is control means for controlling so as to display the popup balloon window 200, which is the window for displaying in relationship to the peripheral equipment, on the displaying means when the peripheral equipment is connected to the predetermined connection position to the information processing terminal apparatus 1.

Therefore, according to the popup balloon window displaying process of FIG. 4, the main processor 11 displays the popup balloon window 200 popup displaying on the liquid crystal panel 31 from a position in the proximity of the connection position to the recording medium 2 every when the recording medium 2 is newly wirelessly connected to the information processing terminal apparatus 1.

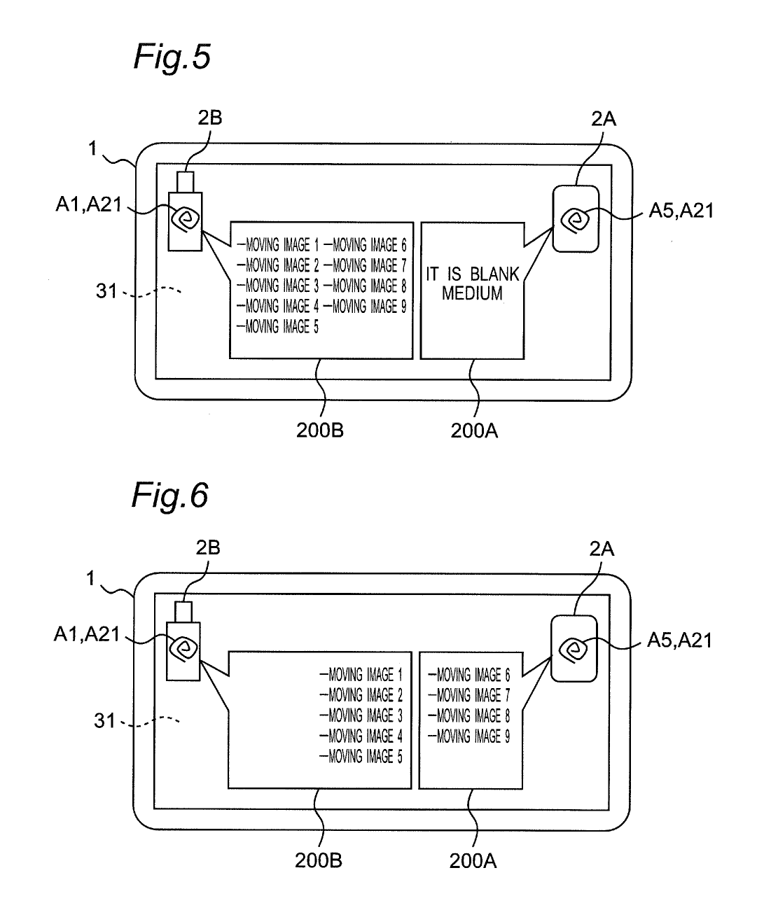

FIG. 5 is a plan diagram showing the first example of popup balloon windows 200A and 200B displayed on the liquid crystal panel 31 when recording media 2A and 2B are wirelessly connected to the information processing terminal apparatus 1 of FIG. 1. As illustrated in FIG. 5, the antenna A21 of the recording medium 2A is opposed to the antenna A5, and the recording medium 2A is wirelessly connected to the information processing terminal apparatus 1 via the antenna A21 of the recording medium 2A and the antenna A5. Further, the popup balloon window 200A is displayed from a position in the proximity of the position of the antenna A5 corresponding to the connection position to the antenna A21 of the recording medium 2A. In this case, no data is stored in the recording medium 2A, and therefore, a message of “It is Blank Media” is displayed within the popup balloon window 200A.

On the other hand, the antenna A21 of the recording medium 2B is opposed to the antenna A1, and the recording medium 2B is wirelessly connected to the information processing terminal apparatus 1 via the antenna A21 of the recording medium 2B and the antenna A1. Further, the popup balloon window 200B is displayed from a position in the proximity of the antenna A1 of the connection position to the antenna A21 of the recording medium 2A. In this case, data of file names of “Moving Image 1 to Moving Image 9” are stored within the recording medium 2B, and therefore, a list of the “Moving Image 1 to Moving Image 9” is displayed in the popup balloon window 200B.

Referring to FIG. 5, when the user drags and drops an icon corresponding to the data within the information processing terminal apparatus 1 into the popup balloon window 200A or 200B, the main processor 11 copies the data within the information processing terminal apparatus 1 into the recording medium 2A or 2B. In addition, when the user drags and drops a file name displayed within the popup balloon window 200B into a window (not shown) representing the nonvolatile memory 12 within the information processing terminal apparatus 1, the main processor 11 copies the data of the file name into the nonvolatile memory 12. Further, when the user drags and drops a file name displayed within the popup balloon window 200B into the popup balloon window 200A, the main processor 11 copies the data of the file name into the nonvolatile memory 22 of the recording media 2A.

Conventionally, when a plurality of recording media 2A and 2B are connected to the information processing terminal apparatus 1, two identical icons corresponding to the respective recording media 2A and 2B, have been displayed. Therefore, it is highly possible to fail in associating the recording media 2A and 2B with the two icons, respectively, and this has led to erroneous operation. On the other hand, according to the present embodiment, the popup balloon window 200 is displayed from a position in the proximity of the connection position to the recording medium 2, and therefore, the popup balloon window 200 is displayed substantially in the position of the actual recording medium 2. That is, since the actual recording medium 2 itself is utilized as the conventional icon, the user does not need to associate the virtual icon with the recording medium 2, and is able to operate the recording medium 2 more intuitively than that of the prior art. That is, the information processing terminal apparatus 1 has an operability higher than that of the prior art information processing terminal apparatus.

The popup balloon windows 200A and 200B are displayed as illustrated in FIG. 5 in the present embodiment. However, the present disclosure is not limited thereto. FIG. 6 is a plan diagram showing the second example of the popup balloon windows 200A and 200B displayed on the liquid crystal panel 31 when the recording media 2A and 2B are wirelessly connected to the information processing terminal apparatus 1 of FIG. 1. Referring to FIG. 6, the file names of the data of the file names of “Moving Image 6 to Moving Image 9” stored within the recording medium 2A are displayed in the popup balloon window 200A in positions near the popup balloon window 200B, respectively. In addition, the file names of the data of the file names of “Moving Image 1 to Moving Image 5” stored within the recording medium 2B are displayed in the popup balloon window 200B in positions near the popup balloon window 200A, respectively. Therefore, for example, a distance from a position where the user drags a file name displayed in the popup balloon window 200B to a position where the user moves the file name into the popup balloon window 200A is shorter than that of FIG. 5, and therefore, when the user copies the data, the operability of FIG. 6 is more improved than that of FIG. 5.

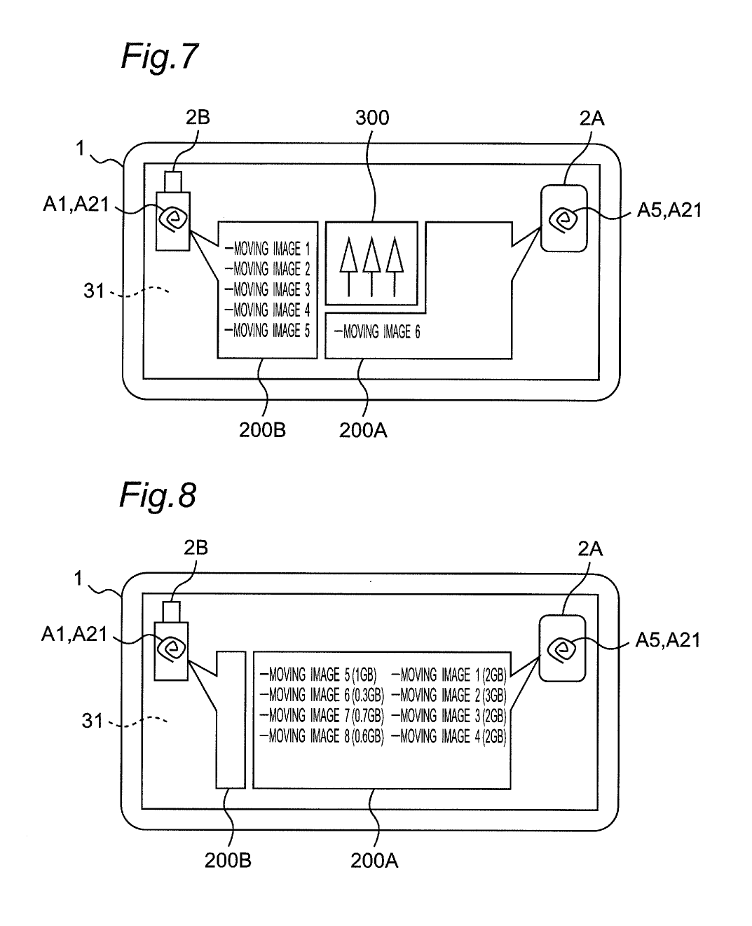

FIG. 7 is a plan diagram showing the third example of the popup balloon windows 200A and 200B displayed on the liquid crystal panel 31 when the recording media 2A and 2B are wirelessly connected to the information processing terminal apparatus 1 of FIG. 1. Referring to FIG. 7, a window 300 displaying the image data within the information processing terminal apparatus 1 has been displayed before the popup balloon window 200A is displayed. Therefore, the popup balloon window 200A is deformed and displayed outside the window 300 so as to have a position adjacent to the popup balloon window 200B. In addition, the file name of the data of the file name of “Moving Image 6” stored within the recording medium 2A is displayed within the popup balloon window 200A in a position near the popup balloon window 200B. Therefore, for example, a distance from a position where the user drags a file name displayed in the popup balloon window 200B to a position where the user moves the file name into the popup balloon window 200A is shorter than that of FIG. 5, and therefore, when the user copies the data, the operability of FIG. 6 is more improved than that of FIG. 5.

FIG. 8 is a plan diagram showing the fourth example of the popup balloon windows 200A and 200B displayed on the liquid crystal panel 31 when the recording media 2A and 2B are wirelessly connected to the information processing terminal apparatus 1 of FIG. 1. Referring to FIG. 8, the data of the file names of “Moving Image 1 to Moving Image 4”, each of which has a size equal to or larger than 2 Gbytes and the data of the file names of “Moving Image 5 to Moving Image 8”, each of which has a size smaller than 2 Gbytes are stored within the recording medium 2A. In addition, the recording medium 2B has a free space of 2 Gbytes, and has no data stored therein. In this case, the main processor 11 retrieves data having a size smaller than 2 Gbytes that can be copied into the recording medium 2B based on the free space of the recording medium 2B and the size of each data stored in the recording medium 2A. Then, the file names of the retrieved data (data of the file names of “Moving Image 5 to Moving Image 8” in the case of FIG. 8) are displayed in the popup balloon window 200A in positions near the popup balloon window 200B, respectively. Therefore, a distance from a position where the user drags a file name displayed in the popup balloon window 200B to a position where the user moves the file name into the popup balloon window 200A is shorter than that of each of FIGS. 5 to 8, and therefore, when the user copies the data, the operability of FIG. 8 is more improved than that of each of FIGS. 5 to 8.

The method for displaying the list of the data within the recording medium 2A is determined based on the free space of the recording medium 2B and the size of each data stored in the recording medium 2A in FIG. 8. However, it is noted that the present disclosure is not limited thereto. For example, data may be retrieved, where the data has a high possibility of being copied from the recording medium 2A to the recording medium 2B on the basis of a predetermined judgment criteria, the file names of the retrieved data may be displayed in the popup balloon window 200A in positions near the popup balloon window 200B, respectively. In addition, nothing is displayed in the popup balloon window 200B in FIG. 8, the present disclosure is not limited to this, and information on the capacity of the recording medium 2B, such as “Free Space is 2 Gbytes” may be displayed.

The file names of the data are displayed in the popup balloon windows 200A and 200B in FIGS. 5 to 8. However, it is noted that the present disclosure is not limited thereto, and thumbnails of the data may be displayed within the popup balloon windows 200A and 200B.

The recording media 2A and 2B are wirelessly connected to the information processing terminal apparatus 1 in the present embodiment. However, the present disclosure is not limited thereto. Peripheral equipment other than the recording media 2A and 2B may be wiredly or wirelessly connected to the information processing terminal apparatus 1.

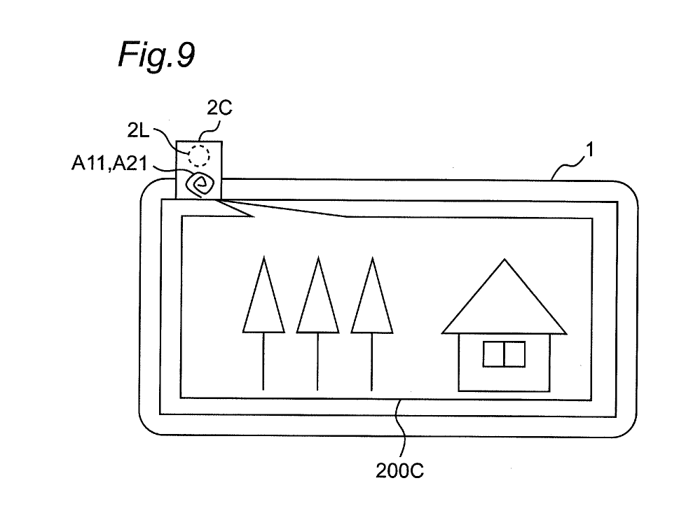

FIG. 9 is a plan diagram showing a popup balloon window 200C displayed on the liquid crystal panel 31 when a camera (peripheral equipment) 2C is wirelessly connected to the information processing terminal apparatus 1 of FIG. 1. Referring to FIG. 9, the information processing terminal apparatus 1 is configured to further include an antenna A11 provided at an upper left end portion within the enclosure of the information processing terminal apparatus 1. In addition, the camera 2C has the same configuration as that of each of the recording media 2A and 2B, and therefore, the camera 2C has an antenna A21, which is attached to the information processing terminal apparatus 1 so that the antenna A21 is opposed to the antenna A11. In this case, a camera lens 2L provided on the back surface of the camera 2C is not hidden by the information processing terminal apparatus 1. Referring to FIG. 9, the main processor 11 displays the popup balloon window 200C from the position of the antenna A11 of the connection position to the camera 2C. In addition, an image photographed by the camera 2C is displayed within the popup balloon window 200C. Therefore, the user can be more easily recognized the image within the popup balloon window 200C photographed by the camera 2C than that of the prior art.

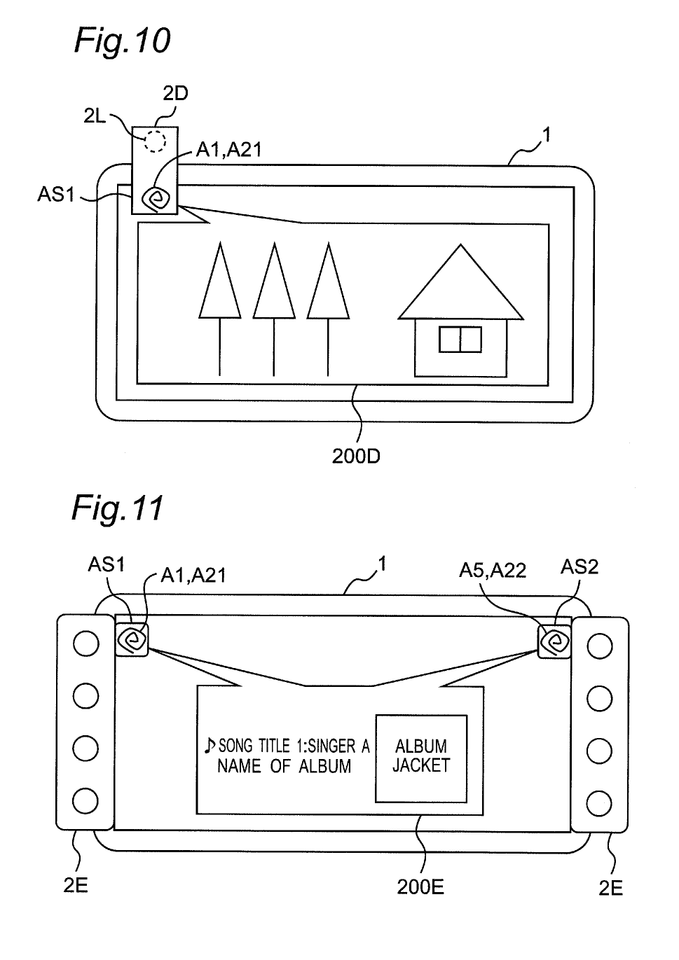

FIG. 10 is a plan diagram showing a popup balloon window 200D displayed on the liquid crystal panel 31 when a camera (peripheral equipment) 2D is wirelessly connected to the information processing terminal apparatus 1 of FIG. 1. Referring to FIG. 10, the camera 2D is configured to include a transparent antenna seal AS1 including the antenna A21. The antenna seal AS1 is attached to a protection film 33 (See FIG. 3) on the liquid crystal panel 31 so that the antenna A21 is opposed to the antenna A1. In this case, the camera lens 2L provided on the back surface of the camera 2D is not hidden by the information processing terminal apparatus 1. Referring to FIG. 10, the main processor 11 displays the popup balloon window 200D from the position of the antenna A1 of the connection position to the camera 2D. In addition, an image photographed by the camera 2D is displayed within the popup balloon window 200D. Therefore, the user can be more easily recognized the image within the popup balloon window 200D photographed by the camera 2D than that of the prior art.

FIG. 11 is a plan diagram showing a popup balloon window 200E displayed on the liquid crystal panel 31 when a speaker (peripheral equipment) 2E is wirelessly connected to the information processing terminal apparatus 1 of FIG. 1. Referring to FIG. 11, the speaker 2E is configured to include a transparent antenna seal AS1 attached to a left speaker, and a transparent antenna seal AS2 attached to a right speaker. In addition, an antenna A21 is formed within the antenna seal AS1, and an antenna A22 is formed within the antenna seal AS2. The antenna seal AS1 is attached to the protection film 33 (See FIG. 3) on the liquid crystal panel 31 so that the antenna A21 is opposed to the antenna A1, and the antenna seal AS2 is stuck to the protection film 33 (See FIG. 3) on the liquid crystal panel 31 so that the antenna A22 is opposed to the antenna A5. In addition, referring to FIG. 11, the main processor 11 displays the popup balloon window 200E from each of the positions of the antennas A1 and A5 of the connection positions of the speaker 2E. Information on the audio data outputted from the speaker 2E is displayed in the popup balloon window 200E.

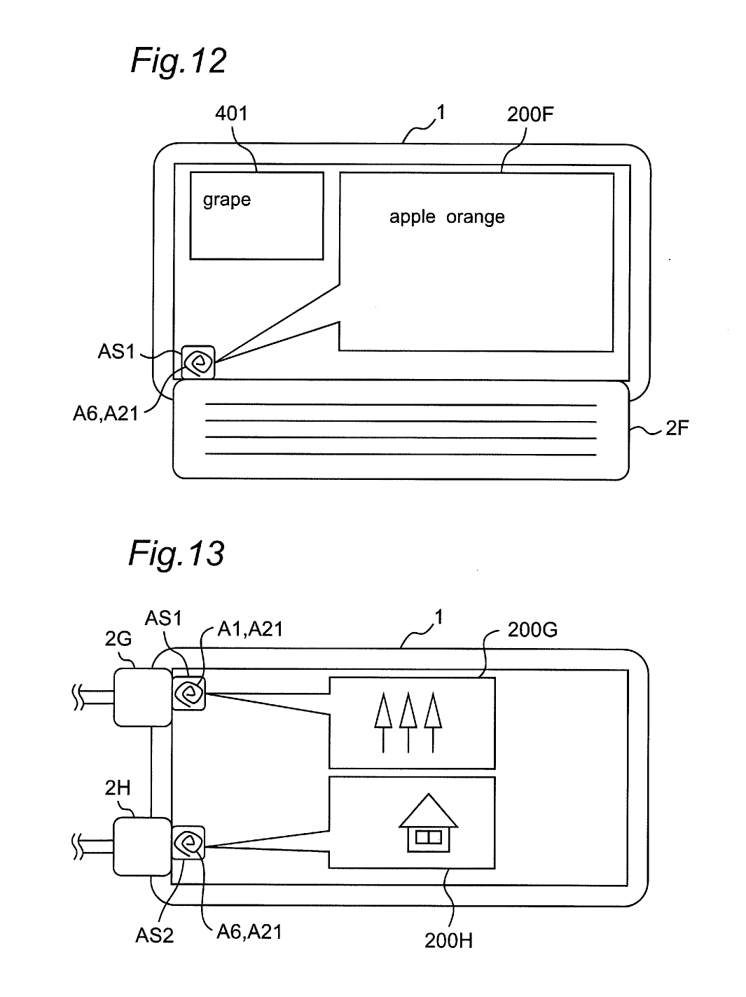

FIG. 12 is a plan diagram showing a popup balloon window 200F displayed on the liquid crystal panel 31 when a keyboard (peripheral equipment) 2F is wirelessly connected to the information processing terminal apparatus 1 of FIG. 1. Referring to FIG. 12, the keyboard 2F is configured to include an antenna seal AS1 including an antenna A21. The antenna seal AS1 is attached to the protection film 33 (See FIG. 3) on the liquid crystal panel 31 so that the antenna A21 is opposed to the antenna A6. In addition, the main processor 11 displays a popup balloon window 200F from the position of the antenna A6 of the connection position to the keyboard 2F. For example, data input in the form of characters from the keyboard 2F by activating application software for forming text data is displayed in the popup balloon window 200F. In addition, a window 401 where the character input from the keyboard 2F is not performed is displayed as a normal window being different from the popup balloon window. Therefore, the user can be more easily recognized a correspondence relation between the window where character input from the keyboard 2F is performed and the keyboard 2F than that of the prior art.

FIG. 13 is a plan diagram showing popup balloon windows 200G and 200H displayed on the liquid crystal panel 31 when an HDMI (registered trademark) (High-Definition Multimedia Interface) connector (peripheral equipment) 2G and a DSUB (D-Subminiature) connector (peripheral equipment) 2G are wirelessly connected to the information processing terminal apparatus 1 of FIG. 1. Referring to FIG. 13, the HDMI (registered trademark) connector 2G is configured to include an antenna seal AS1 including an antenna A21, and the antenna seal AS1 is attached to the protection film 33 (See FIG. 3) on the liquid crystal panel 31 so that the antenna A21 is opposed to the antenna A1. In addition, the DSUB connector 2H is configured to include an antenna seal AS2 including an antenna A21, and the antenna seal AS2 is attached to the protection film 33 on the liquid crystal panel 31 so that the antenna A21 is opposed to the antenna A6. In addition, the main processor 11 displays the popup balloon window 200G from the position of the antenna A1 of the connection position to the HDMI (registered trademark) connector 2G, and displays the popup balloon window 200H from the position of the antenna A6 of the connection position to the DSUB connector 2H. Then, moving image data output from the information processing terminal apparatus 1 via the HDMI (registered trademark) connector 2G is displayed within the popup balloon window 200G, and moving image data output from the information processing terminal apparatus 1 via the DSUB connector 2H is displayed within the popup balloon window 200H. Therefore, the user can be more easily recognized the moving data outputted from each of the connectors 2G and 2H than that of the prior art.

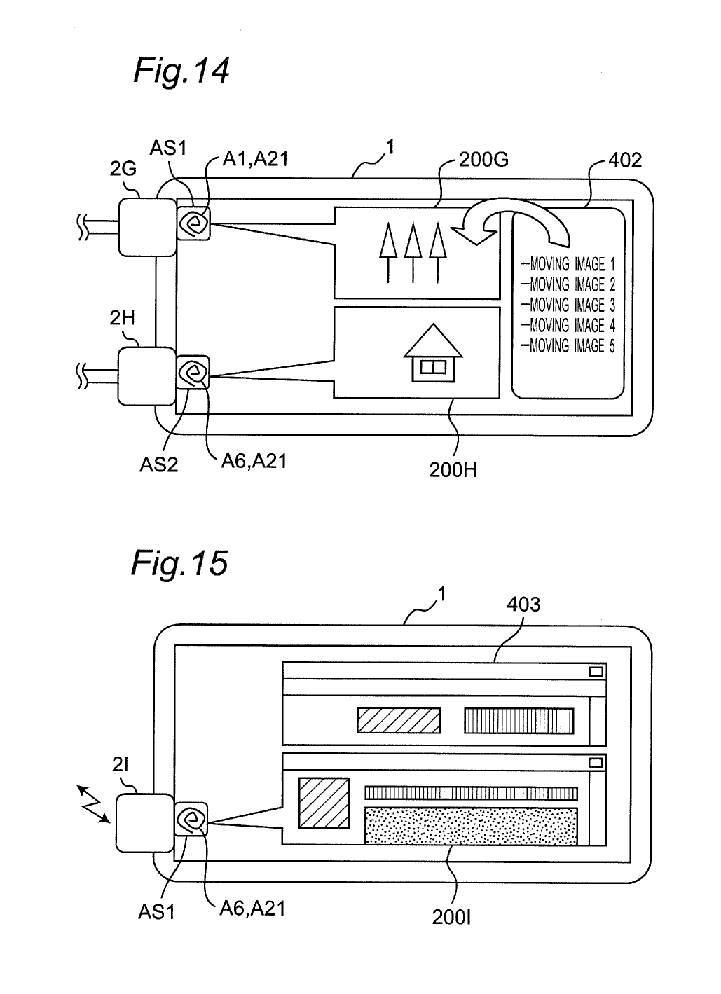

FIG. 14 is a plan diagram showing user's flick operation when the data in the information processing terminal apparatus 1 is output from the HDMI (registered trademark) connector 2G in FIG. 13. Referring to FIG. 14, file names of the data in the information processing terminal apparatus 1 are displayed in the window 402. When the user flicks a file name within the window 402 to the popup balloon window 200G, the main processor 11 outputs the data of the file name via the HDMI (registered trademark) connector 2G. In addition, when the user flicks a file name in the window 402 to the popup balloon window 200H, the main processor 11 outputs the data of the file name via the DSUB connector 2H. Therefore, the user can more easily output the moving image data output from each of the connectors 2G and 2H via the desired connector 2G or 2H than that of the prior art.

FIG. 15 is a plan diagram showing a popup balloon window 200I displayed on the liquid crystal panel 31 when a wireless LAN (Local Area Network) adapter (peripheral equipment) 2I is wirelessly connected to the information processing terminal apparatus 1 of FIG. 1. Referring to FIG. 15, the wireless LAN adapter 2I is configured to include an antenna seal AS1 including an antenna A21, and the antenna seal AS1 is attached to the protection film 33 (See FIG. 3) on the liquid crystal panel 31 so that the antenna A21 is opposed to the antenna A6. In addition, the main processor 11 displays the popup balloon window 200I from the position of the antenna A6 of the connection position to the wireless LAN adapter 2I. The information processing terminal apparatus 1 is wirelessly connected to the Internet via the wireless LAN adapter 2I, and a web page is displayed in the popup balloon window 200I. It is noted that data obtained via a built-in telephone line interface of the information processing terminal apparatus 1 is displayed in a normal window 403 being different from the popup balloon window. Therefore, the user can more easily recognize that the web page displayed in the popup balloon window 200I is obtained by the wireless LAN adapter 2I than that of the prior art.

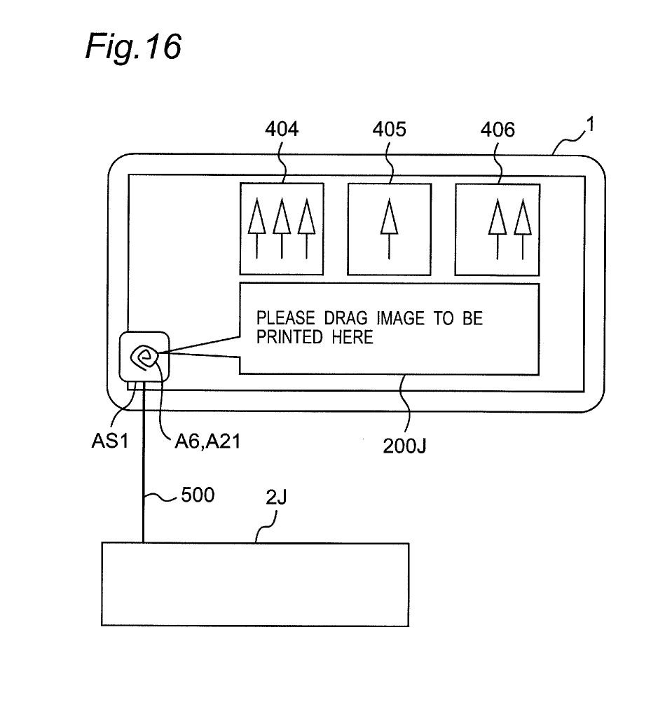

FIG. 16 is a plan diagram showing a popup balloon window 200J displayed on the liquid crystal panel 31 when a printer (peripheral equipment) 2J is wirelessly connected to the information processing terminal apparatus 1 of FIG. 1. Referring to FIG. 16, the printer 2J is wirelessly connected to the information processing terminal apparatus 1 via a cable 500 provided with an antenna seal AS1 including the antenna A21. The antenna seal AS1 is attached to the protection film 33 (See FIG. 3) on the liquid crystal panel 31 so that the antenna A21 is opposed to the antenna A6. In addition, the main processor 11 displays the popup balloon window 200J from the position of the antenna A6 of the connection position to the cable 500, and displays image data within the information processing terminal apparatus 1 in windows 404 to 406. Further, the main processor 11 displays a message of “Drag Printed Image Here” in the popup balloon window 200J. When the user drags and drops the window 404, 405 or 406 to the popup balloon window 200J or in the proximity of the antenna seal AS1, the main processor 11 outputs the dragged image data to the printer 2J via the cable 500 to print the data. Therefore, the user can more easily print the image data than that of the prior art.

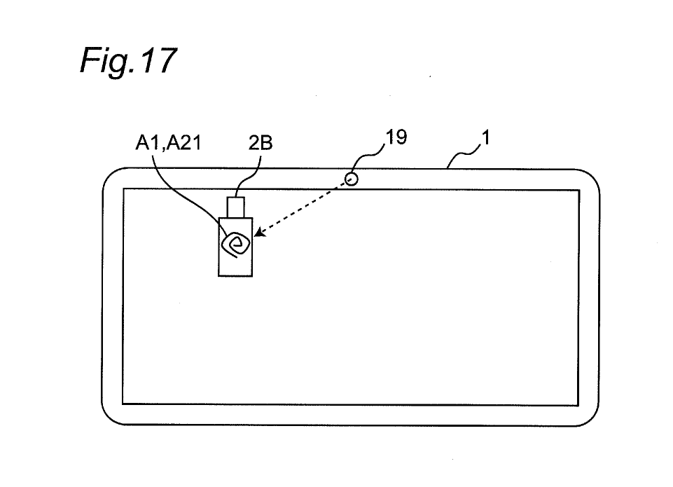

The main processor 11 obtains the position of the antenna connected to the antenna A21 and/or A22 of the peripheral equipment 2A to 2J, among the antennas A1 to A10, as the connection position to the peripheral equipment 2A to 2J in the present embodiment. However, the present disclosure is not limited thereto. The main processor 11 may obtain the position of the peripheral equipment detected by detection means for detecting the connection position to the peripheral equipment 2A to 2J as the connection position to the peripheral equipment. FIG. 17 is a plan diagram showing a detection method of the connection position to the recording medium 2B by an information processing terminal apparatus 1 according to a modified embodiment of the first embodiment of the present disclosure. Referring to FIG. 17, the main processor 11 photographs the recording medium 2B by using an image pickup element 19, and detects the connection position to the recording medium 2B based on the photographed image data. In addition, the main processor 11 may detect the connection positions of the peripheral equipment 2A to 2J by using a detection signal from a touch sensor 16 that detects a touch position on the touch panel 32.

### Second Embodiment

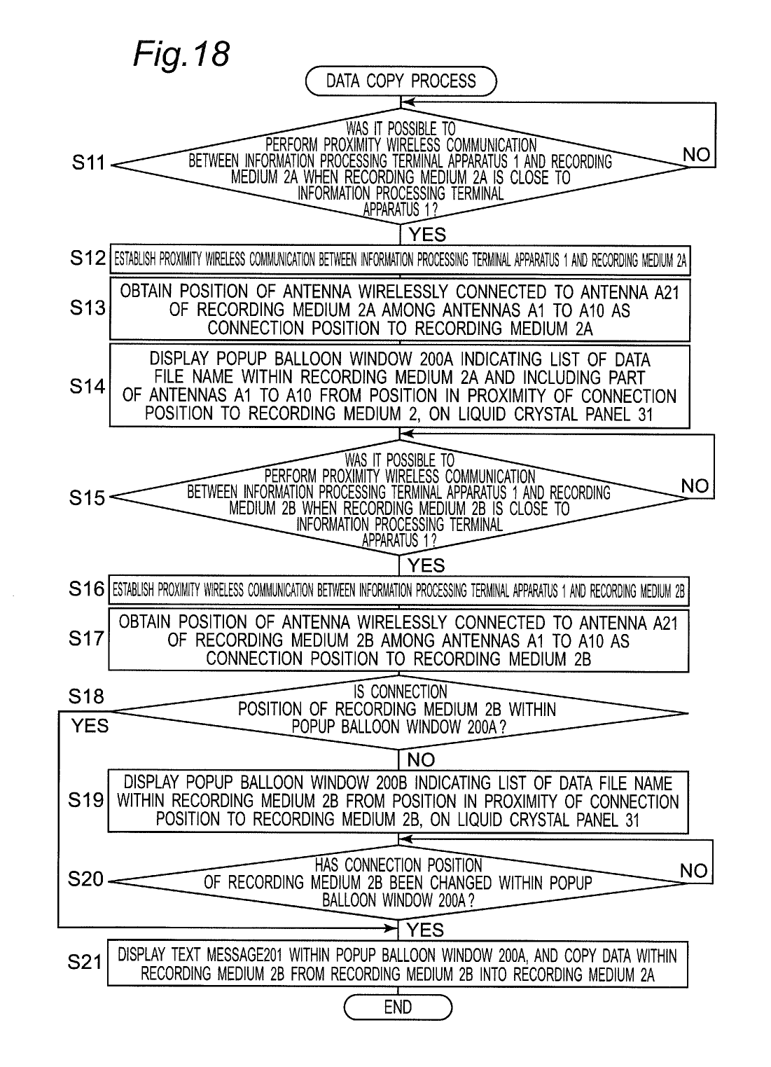

FIG. 18 is a flow chart showing a data copy process executed by the main processor 11 of FIG. 2 according to a second embodiment of the present disclosure. First of all, in step S11, the main processor 11 judges whether or not it is possible to perform a proximity wireless communication between the information processing terminal apparatus 1 and the recording medium 2A when the recording medium 2A is close to the information processing terminal apparatus 1. Then, if it is YES in step S11, the process proceeds to step S12. On the other hand, if it is NO, the process of step S11 is repeatedly executed. In step S12, the main processor 11 establishes proximity wireless communication between the information processing terminal apparatus 1 and the recording medium 2A. Next, in step S14, the main processor 11 obtains the position of the antenna wirelessly connected to the antenna A21 of the recording medium 2A among the antennas A1 to A10 as the connection position to the recording medium 2A. It is noted that each of the processes of steps S11 to S13 is similar to each of the processes of steps S1 to S3 of FIG. 4, respectively.

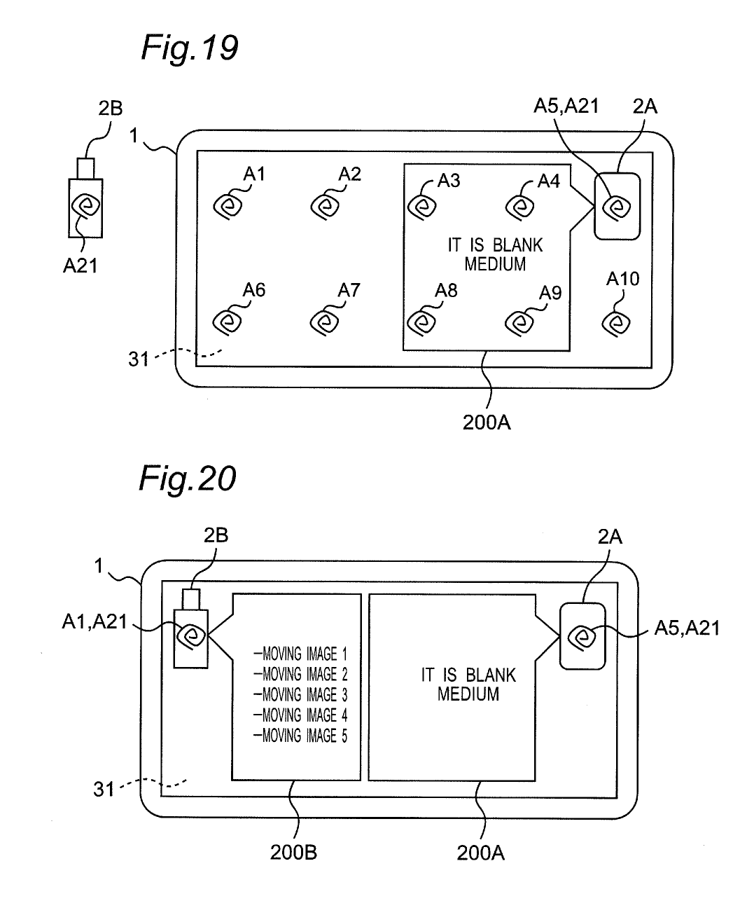

Following step S13, in step S14, the main processor 11 displays the list of the file names of data in the recording medium 2A on the liquid crystal panel 31, and displays the popup balloon window 200A including part of the antennas of the antennas A1 to A10 from a position in the proximity of the connection position to the recording medium 2A. FIG. 19 is a plan diagram showing one example of the popup balloon window 200A displayed on the liquid crystal panel 31 in step S14 of FIG. 18. Referring to FIG. 19, the antenna A21 of the recording medium 2A is opposed to the antenna A5. In addition, a popup balloon window 200A is displayed from the position of the antenna A5 of the connection position to the recording medium 2A, where the popup balloon window 200A includes the antennas A3, A4, A8 and A9 and does not include the antennas A1, A2, A6, A7 and A10. Further, a text message of “It Is Blank Medium” representing that there is no data stored in the recording medium 2A is displayed in the popup balloon window 200A.

Following step S14, in step S15, the main processor 11 judges whether or not it is possible to perform the proximity wireless communication between the information processing terminal apparatus 1 and the recording medium 2B when the recording medium 2B is close to the information processing terminal apparatus 1. Then, if it is YES in step S15, the process proceeds to step S16. On the other hand, if it is NO, the process of step S15 is repeatedly executed. In step S16, the main processor 11 establishes the proximity wireless communication between the information processing terminal apparatus 1 and the recording medium 2B, and obtains in step S17 the position of the antenna wirelessly connected to the antenna A21 of the recording medium 2B among the antennas A1 to A10 as the connection position to the recording medium 2B. It is noted that each of the processes of steps S15 to S17 is similar to each of the processes of steps S11 to S13, respectively.

Following step S16, in step S17, the main processor 11 judges whether or not the connection position to the recording medium 2B is within the popup balloon window 200A. If it is YES, the process proceeds to step S21. On the other hand, if it is NO, the process proceeds to step S19. In step S19, the main processor 11 displays the popup balloon window 200B pop displaying the list of the file names of the data within the recording medium 2B on the liquid crystal panel 31 from a position in the proximity of the connection position to the recording medium 2B. FIG. 20 is a plan diagram showing one example of the popup balloon window 200B displayed on the liquid crystal panel 31 in step S19 of FIG. 18. Referring to FIG. 20, the antenna A21 of the recording medium 2B is opposed to the antenna A1. In addition, the popup balloon window 200B is displayed from the position of the antenna A1 of the connection position to the recording medium 2B. Further, since the data of the file names of “Moving Image 1 to Moving Image 5” are stored within the recording medium 2B, the list of the “Moving Image 1 to Moving Image 5” is displayed in the popup balloon window 200B. Referring to FIG. 20, when a file name displayed in the popup balloon window 200B is dragged and dropped into the popup balloon window 200A, the main processor 11 copies the data of the file name to the nonvolatile memory 22 of the recording data medium 2A.

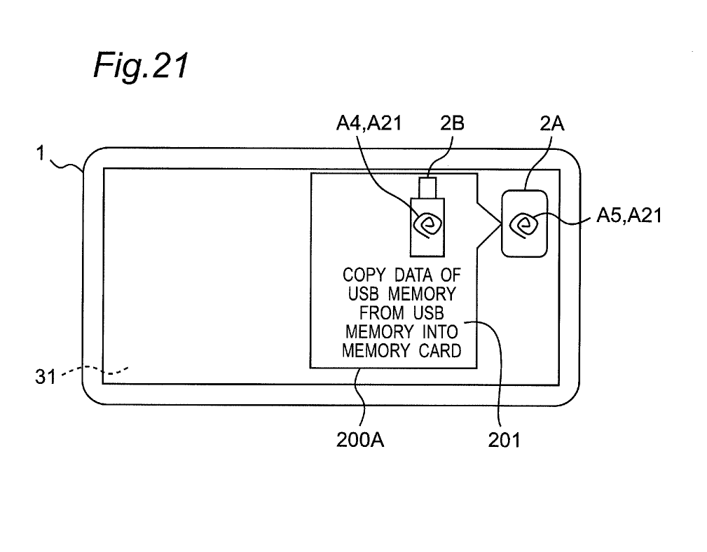

Following step S19, in step S20, the main processor 11 judges whether or not the connection position to the recording medium 2B has changed within the popup balloon window 200A. If it is YES, the process proceeds to step S21. On the other hand, if it is NO, the process of step S20 is repeatedly executed. In step S21, the Main processor 11 displays the text message 201 within the popup balloon window 200A, copies the data within the recording medium 2B into the recording data media 2A, and ends the data copy process. FIG. 21 is a plan diagram showing one example of the text message 201 displayed on the liquid crystal panel 31 in step S21 of FIG. 18. Referring to FIG. 21, the antenna A21 of the recording medium 2B is opposed to the antenna A4. In addition, a text message 201 of “Copy data of USB Memory From USB Memory Into Memory Card” is displayed in the popup balloon window 200A, where the text message 201 indicates that the data within the recording medium 2B is copied into the recording medium 2A.

As described above, according to the present embodiment, when the recording medium 2B is placed within the popup balloon window 200A of the recording medium 2A previously wirelessly connected to the information processing terminal apparatus 1, the data within the recording medium 2B is automatically copied into the recording medium 2A. Therefore, according to the present embodiment, the user can more intuitively operate the recording media 2A and 2B than that of the prior art, and the user's operability can be more improved than that of the prior art.

### Third Embodiment

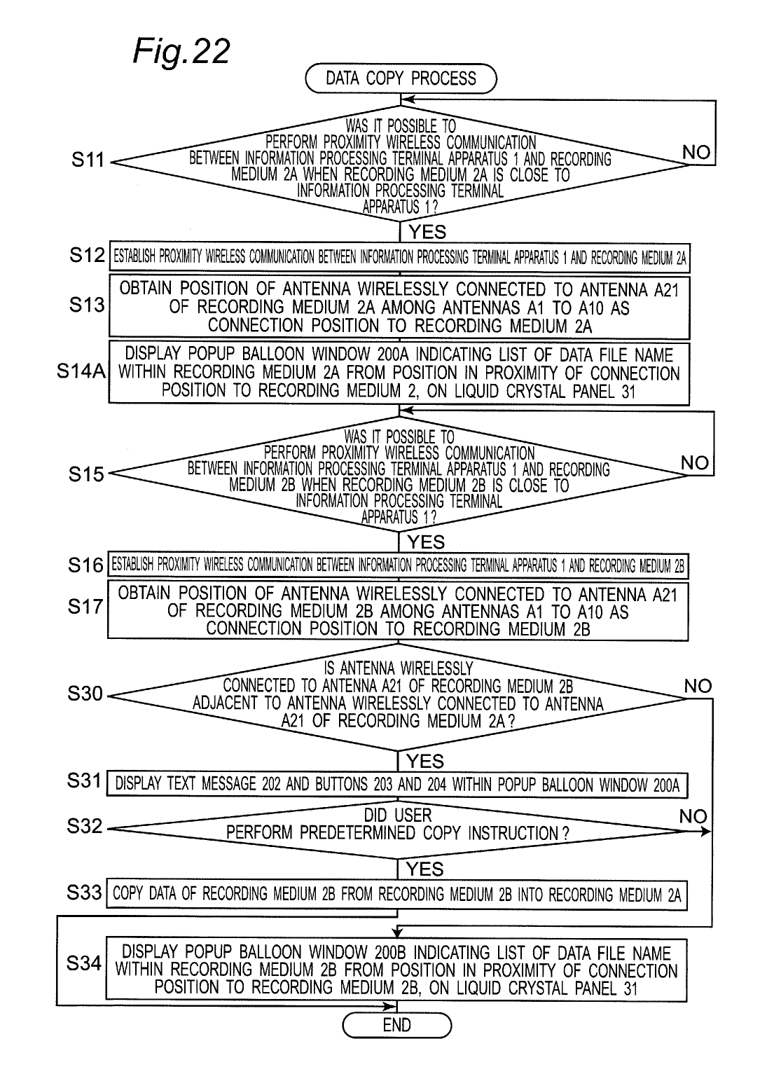

FIG. 22 is a flow chart showing a data copy process executed by the main processor 11 of FIG. 2 according to a third embodiment of the present disclosure. When the data copy process of FIG. 22 is compared with the data copy process of FIG. 22, the process of step S14 is replaced by a process of step S14A, and the processes of steps S18 to S21 are replaced by the processes of steps S30 to S34. Only a difference between the data copy process of FIG. 18 and the data copy process of FIG. 22 will be described below.

In step S14A, the main processor 11 displays the popup balloon window 200A popup displaying the list of the file names of the data in the recording medium 2A on the liquid crystal panel 31 from a position in the proximity of the connection position to the recording medium 2A. In addition, in step S30 following step S17, the main processor 11 judges whether or not the antenna wirelessly connected to the antenna A21 of the recording medium 2B is located adjacent to the antenna wirelessly connected to the antenna A21 of the recording medium 2A. Then, if it is YES in step S30, the process proceeds to step S31. On the other hand, if it is NO, the process proceeds to step S34, the popup balloon window 200B popup displaying the list of the file names of the data in the recording medium 2B is displayed on the liquid crystal panel from a position in the proximity of the connection position to the recording medium 2B, and the data copy process ends.

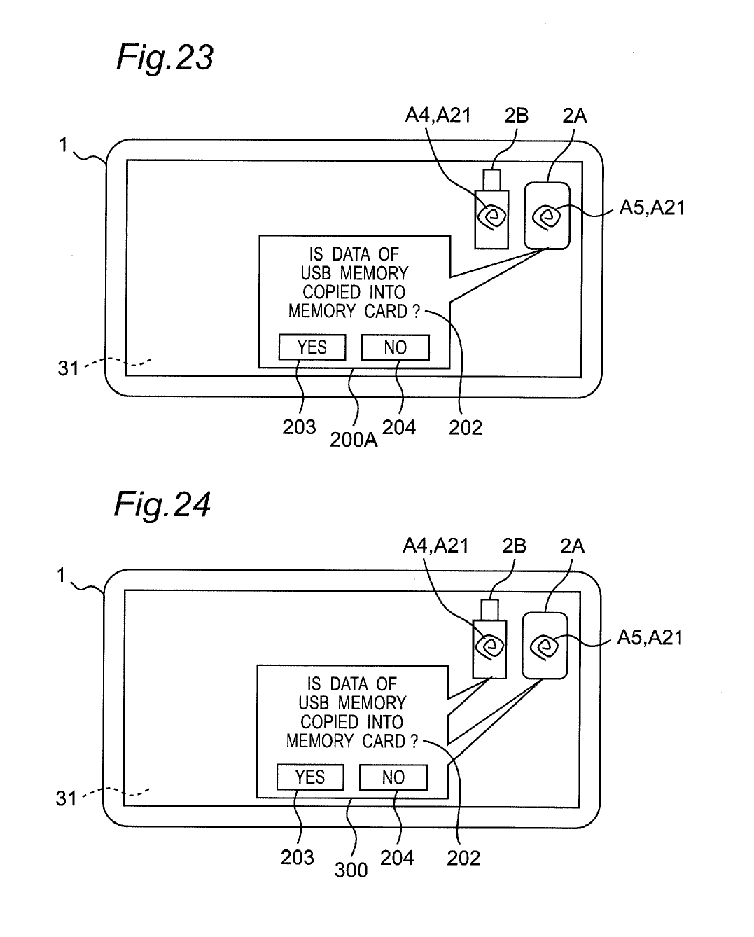

In step S31, the main processor 11 displays a text message 202 and buttons 203 and 204 in the popup balloon window 200A. FIG. 23 is a plan diagram showing one example of the text message 202 and the buttons 203 and 204 displayed on the liquid crystal panel 31 in step S31 of FIG. 22. Referring to FIG. 23, the antenna A21 of the recording medium 2A previously wirelessly connected to the information processing terminal apparatus 1 is opposed to the antenna A5. In addition, the recording medium 2B is placed so that the antenna A21 of the recording medium 2B is opposed to the antenna A4. Therefore, since the antenna A4 wirelessly connected to the antenna A21 of the recording medium 2B is located adjacent to the antenna A5 wirelessly connected to the antenna A21 of the recording medium 2A, the main processor 11 judges that it is Yes in step S30. Therefore, such a text message 202 that “Is Data of USB Memory Copied Into Memory Card?”, a button 203 of “YES”, and a button 204 of “No” are displayed within the popup balloon window 200A.

Following step S31, in step S32, it is judged whether or not the user performed a predetermined copy instruction. If it is YES, the process proceeds to step S33. On the other hand, if it is NO, the process proceeds to step S34. Concretely speaking, when the user taps the button 203 of FIG. 23, the main processor 11 judges that it is YES in step S31. In step S33, the main processor 11 copies the data in the recording medium 2B into the recording medium 2A, and ends the data copy process.

As described above, according to the present embodiment, when the recording medium 2B is wirelessly connected to the connection position adjacent to the connection position to the recording medium 2A previously wirelessly connected to the information processing terminal apparatus 1, the data within the recording medium 2B can be copied into the recording medium 2A. Therefore, according to the present embodiment, the user can more intuitively operate the recording media 2A and 2B than that of prior art, and the user's operability can be more improved than that of the prior art.

Referring to FIG. 22, if it is YES in step S30, the process in step S33 may be executed without performing the processes in steps S31 and S32.

In addition, the text message 202 and the buttons 203 and 204 are displayed within the popup balloon window 200A in the present embodiment as illustrated in FIG. 23. However, the present disclosure is not limited thereto. FIG. 24 is a plan diagram showing another example of the text message 202 and the buttons 203 and 204 displayed on the liquid crystal panel 31 in step S31 of FIG. 22. As illustrated in FIG. 24, one popup balloon window 300 instead of the popup balloon window 200A may be displayed from a position in the proximity of each connection position to the recording media 2A and 2B, and the text message 202 and the buttons 203 and 204 may be displayed within the popup balloon window 300. Therefore, since the user can more visually recognize the equipment related to the data copy process than that of FIG. 23, the user can avoid using the recording media 2A and 2B improperly.

### Fourth Embodiment

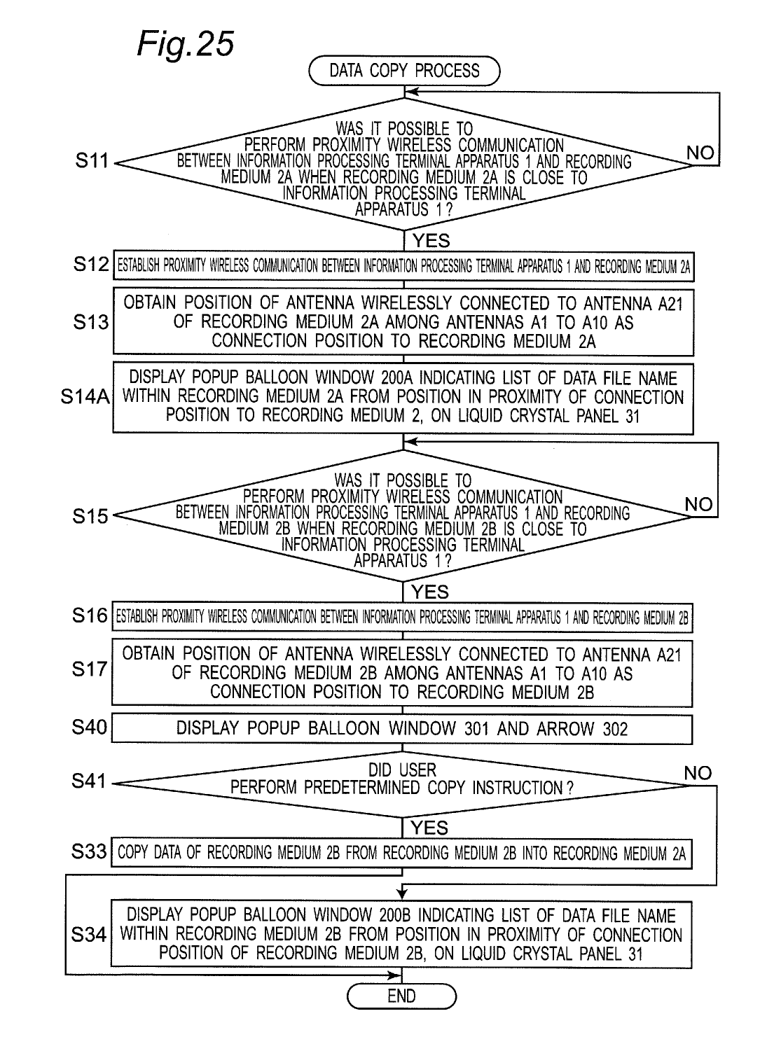

FIG. 25 is a flow chart showing a data copy process executed by the main processor 11 of FIG. 2 according to a fourth embodiment of the present disclosure. When the data copy process of FIG. 25 is compared with the data copy process of FIG. 22, the processes of steps S30 to S32 are replaced by the processes of steps S40 to S41. Only a difference between the data copy process of FIG. 25 and the data copy process of FIG. 22 will be described below.

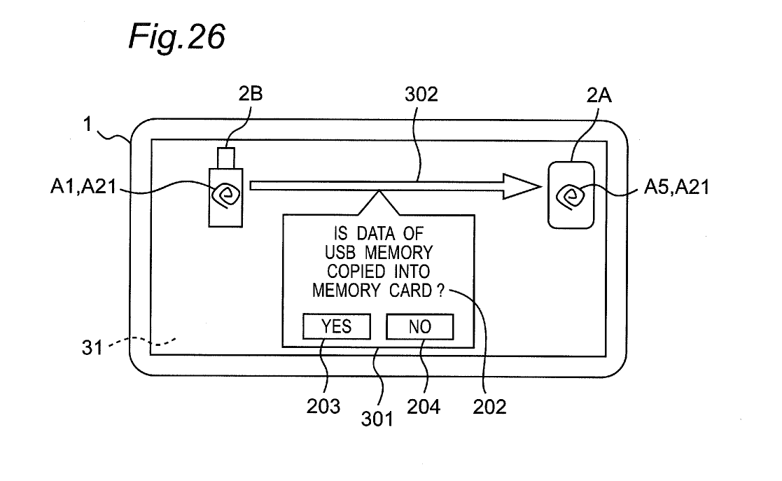

Following step S17, in step S40, the main processor 11 displays a popup balloon window 301 and an arrow 302. FIG. 26 is a plan diagram showing one example of the popup balloon window 301 and the arrow 302 displayed on the liquid crystal panel 31 in step S40 of FIG. 25. Referring to FIG. 26, the antenna A21 of the recording medium 2A is opposed to the antenna A5, and the antenna A21 of the recording medium 2B is opposed to the antenna A1. In addition, the arrow 302 is displayed from a position in the proximity of the connection position to the recording medium 2B of the copy source toward the connection position to the recording medium 2A of the copy destination. Further, the popup balloon window 301 is displayed from the central portion of the arrow 302, and the same text message 202 and buttons 203 and 204 as those of FIG. 23 are displayed within the popup balloon window 301.

Following step S40 of FIG. 25, in step S41, the main processor judges whether or not the user performed a predetermined copy instruction. If it is YES, the process proceeds to step S33. On the other hand, if it is NO, the process proceeds to step S34. Concretely speaking, when the user taps the button 203 of FIG. 26, the main processor 11 judges that it is YES in step S41.

As described above, according to the present embodiment, the data of the recording medium 2B subsequently wirelessly connected to the information processing terminal apparatus 1 can be automatically copied to the recording medium 2A previously wirelessly connected to the information processing terminal apparatus 1. Therefore, according to the present embodiment, the user can more intuitively operate the recording media 2A and 2B than that of the prior art, and the user's operability can be more improved than that of the prior art.

The data copy process between the two recording media 2A and 2B has been described in the second to fourth embodiments. However, it is noted that the present disclosure is not limited thereto. The data copy process may be performed between arbitrary two units of peripheral equipment of the peripheral equipment 2A to 2J. For example, the information processing terminal apparatus 1 may control so as to output all the data within the recording medium 2A via the cable 500 and the antenna seal AS1 to the printer 2J to print the data when the printer 2J of FIG. 16 is wirelessly connected to the antenna within the wireless connection 200A of the recording medium 2A previously wirelessly connected to the information processing terminal apparatus 1.

In addition, referring to the second to fourth embodiments, the recording medium 2B subsequently connected to the information processing terminal apparatus 1 among the recording media 2A and 2B is set as the recording medium of the copy source, and the recording medium 2A previously connected to the information processing terminal apparatus 1 is set as the recording medium of the copy destination. However, the present disclosure is not limited thereto. For example, the user may set the recording medium the recording medium by slid the user as the recording medium of the copy source by sliding one of the recording media 2A and 2B

In addition, referring to each of the above-described embodiments, the antennas A1 to A11 and A21 to A22 are the antenna coils for transmitting and receiving. However, the present disclosure is not limited thereto. For example, an antenna coil for transmitting and an antenna coil for receiving may be separately provided.

Further, referring to each of the above-described embodiments, the peripheral equipment 2A to 2J are wirelessly connected to the information processing terminal apparatus 1. However, the present disclosure is not limited thereto. The peripheral equipment 2A to 2J may be wiredly connected to the information processing terminal apparatus 1. In this case, the position of the connection connector of the information processing terminal apparatus 1 may be used as the connection position to the peripheral equipment 2A to 2J.

Furthermore, referring to each of the above-described embodiments, the popup balloon windows 200A to 200J are displayed from the positions in the proximity of the connection positions to the peripheral equipment 2A to 2J, the present disclosure is not limited thereto. However, the present disclosure is not limited thereto. For example, the popup balloon windows 200A to 200J may be displayed from the connection positions to the peripheral equipment 2A to 2J.

In addition, when a plurality of peripheral equipment is connected to the plurality of respective predetermined connection positions of the information processing terminal apparatus 1, the main processor 11 may change the display method of the popup balloon window to each peripheral equipment based on at least one of the types of the plurality of peripheral equipment, the connection positions thereof, and the connection orders thereof. In this case, the type of the peripheral equipment is, for example, recording media, camera, speaker, keyboard, HDMI (registered trademark) connector, DSUB connector, wireless LAN adapter or printer.

Further, when a plurality of peripheral equipment is connected to the plurality of respective predetermined connection positions of the information processing terminal apparatus 1, the main processor 11 may execute a predetermined process based on the at least one of the types of the plurality of peripheral equipment, the connection positions thereof, and the connection orders thereof.

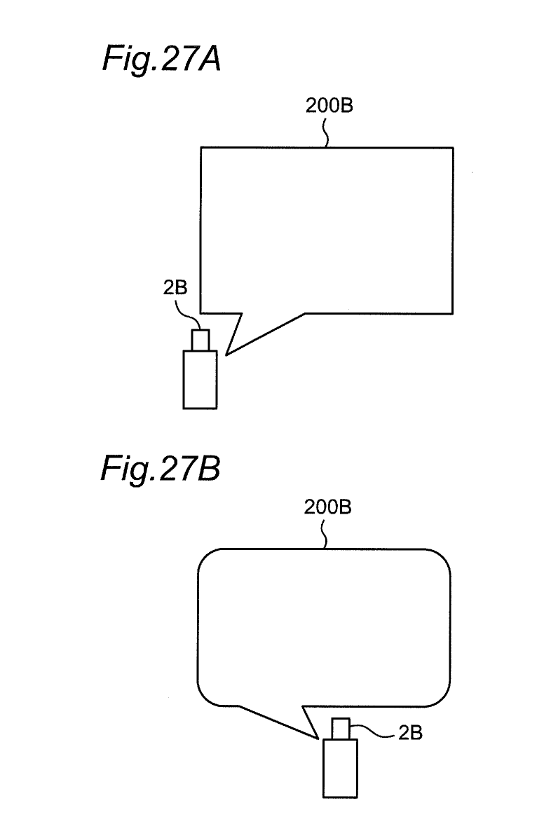

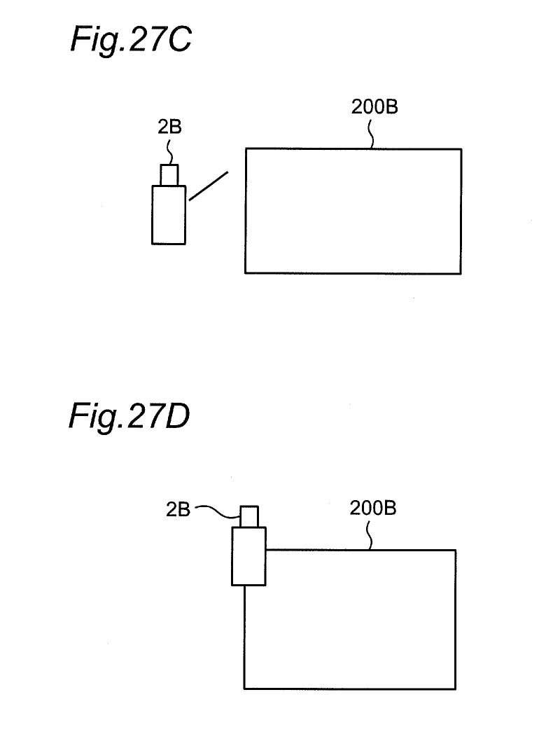

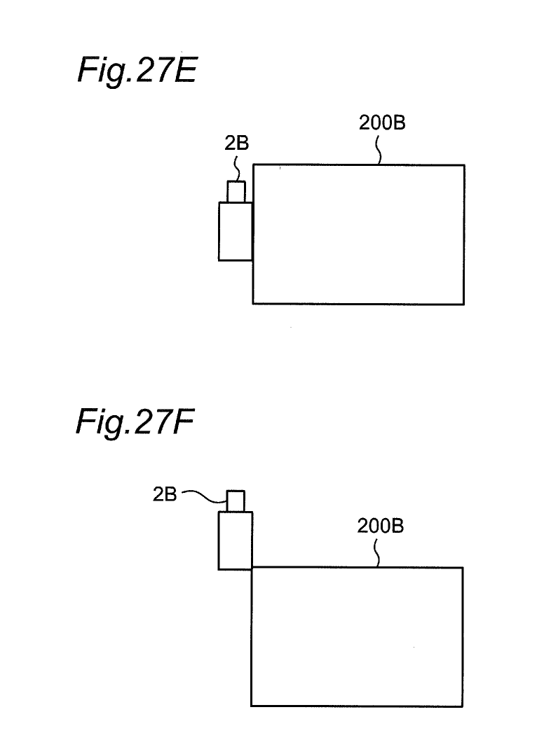

Furthermore, referring to each of the above-described embodiments, the popup balloon window 200B is displayed as illustrated in FIG. 5. However, the present disclosure is not limited thereto. For example, the popup balloon window 200B may be displayed as illustrated in FIG. 27A, FIG. 27B, FIG. 27C, FIG. 27D, FIG. 27E, FIG. 27F or the like. That is, the popup balloon window 200B may pop up in whichever shape or from whichever position as long as the popup balloon window 200B pops up so as to have a relation with the recording medium 2B of a USB memory or the like. For example, as illustrated in FIG. 27D, the popup balloon window 200B may pop up so as to partially overlap the recording medium 2B. In addition, as illustrated in FIG. 27E, the popup balloon window 200B may pop up so as to be adjacent to an edge of the recording medium 2B. Further, as illustrated in FIG. 27F, the popup balloon window 200B may pop up so that a corner of the recording medium 2B overlaps a corner of the popup balloon window 200B. Referring to the above-described modified embodiments, the popup balloon window 200B popping up from the recording medium 2B has been described. However, it is possible that the popup balloon window 200A popping from the recording media 2A has the same modifications as those of the popup balloon window 200B popping up from the recording medium 2B.

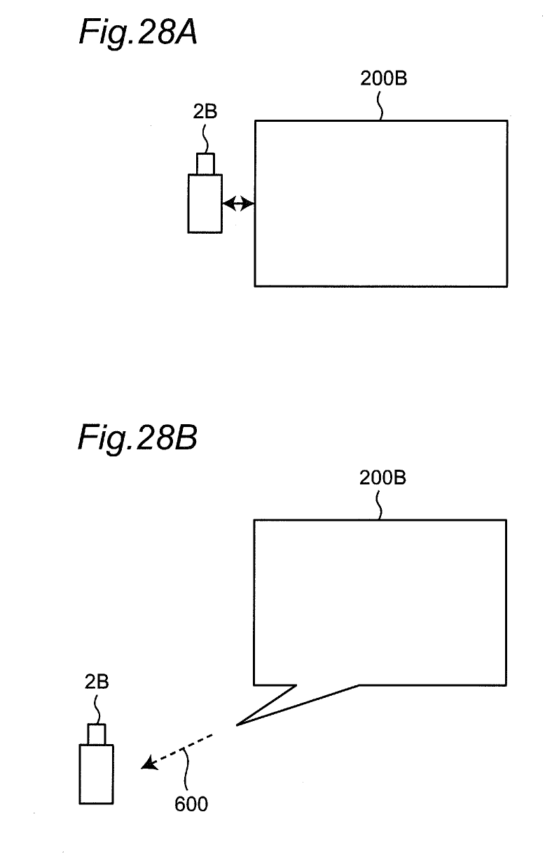

In addition, referring to each of the above-described embodiments, the popup balloon window 200B pops up from a position in the proximity of the connection position to the recording medium 2B as illustrated in FIG. 5. In this case, as illustrated in FIG. 28A, the “proximity” means a range within several centimeters from the connection position to the recording medium 2B. Further, as illustrated in FIG. 28B, the popup balloon window 200B may pop up from a position other than the proximity of the connection position to the recording medium 2B. For example, it corresponds to a case where the popup direction is directed toward the recording medium 2B such as a USB memory as indicated by an arrow 600, and there is not any connected object between the popup balloon window 200B and the recording medium 2B. In this case, the popup balloon window 200B has been described as an example, the popup balloon window 200A has the same configuration as that of the popup balloon window 200B. It is noted that the definition of the “proximity” other than the “proximity” used in explaining the positions where the popup balloon windows 200A and 200B pop up is within several centimeters from the position of contact with the actual object to be overlapped.

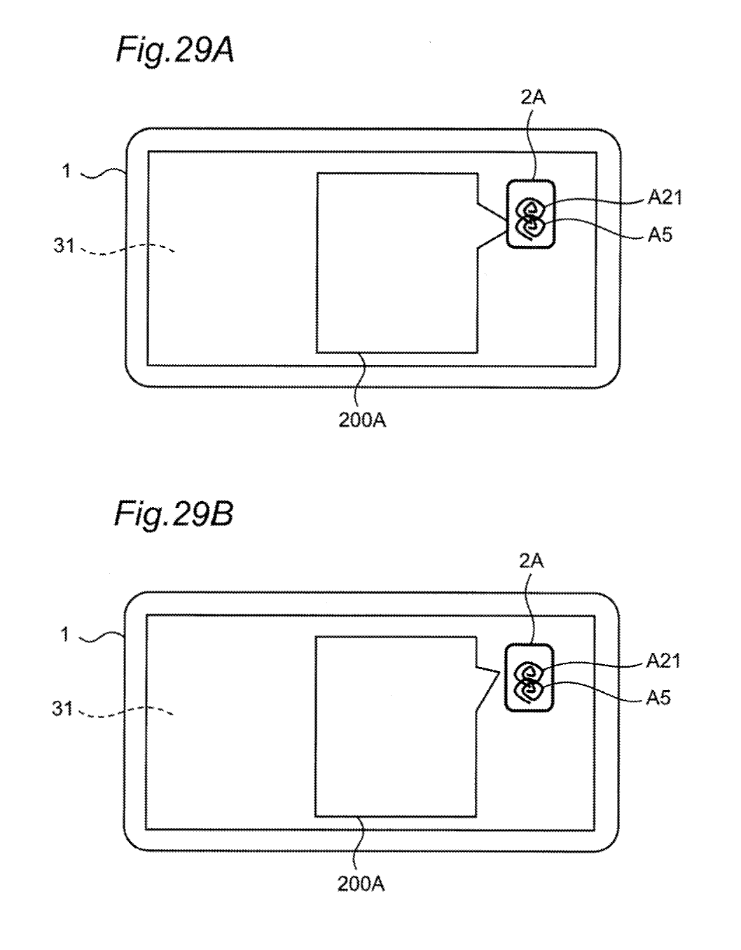

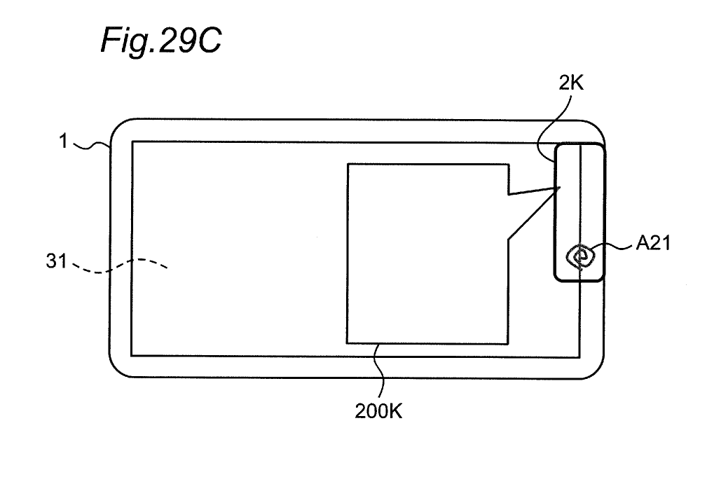

Further, referring to each of the above-described embodiments, the popup balloon window 200A pops up in the proximity of the recording medium 2A as illustrated in FIG. 5 when the antenna A5 and the antenna A21 overlap one another. However, the present disclosure is not limited thereto. For example, as illustrated in FIG. 29A, the popup balloon window 200A may pop up from the antenna A5 of the information processing terminal apparatus 1 when the antenna A5 and the antenna A21 partially overlap one another. In addition, as illustrated in FIG. 29B, the position where the popup balloon window 200A pops up may be determined in consideration of the size of the recording medium 2A placed on the information processing terminal apparatus 1. Further, as illustrated in FIG. 29C, in the case of a recording medium 2K of a type of a clip shape to be held at an edge of the information processing terminal apparatus 1, the antenna A21 of the recording medium 2K may be located in a portion corresponding to the connector of the information processing terminal apparatus 1, and a popup balloon window 200K may pop up from the recording medium 2K.

As described above, according to the information processing terminal apparatus of the first aspect, in the information processing terminal apparatus having displaying means configured to display predetermined information, the information processing terminal apparatus includes control means configured to control the displaying means to display a window displaying in relationship to the peripheral equipment on the displaying means when peripheral equipment is connected to a predetermined connection position of the information processing terminal apparatus.

Therefore, the user can more intuitively operate the peripheral equipment connected to the information processing terminal apparatus than that of the prior art.

According to the information processing terminal apparatus of the second aspect, in the information processing terminal apparatus according to the first aspect, the window is popup-displayed from the connection position on the displaying means or a position in the proximity thereof.

According to the information processing terminal apparatus of the third aspect, in the information processing terminal apparatus according to the first or second aspect, the window is displayed so as to partially overlap the peripheral equipment or so as to be in contact with the peripheral equipment.

According to the information processing terminal apparatus of the fourth aspect, in the information processing terminal apparatus according to any one of the first to third aspects, the control means displays the information related to the peripheral equipment within the window.

Therefore, the user can recognize the information related to the peripheral equipment such as the data stored in the peripheral equipment by the popup balloon window.

According to the information processing terminal apparatus of the fifth aspect, in the information processing terminal apparatus according to any one of the first to fourth aspects, the information processing terminal apparatus further includes at least one first antenna formed of a transparent conductive film on a front surface of the displaying means. The peripheral equipment includes a second antenna, and the control means obtains the position of the one antenna as the connection position when the peripheral equipment is wirelessly connected to the information processing terminal apparatus with the second antenna opposed to one antenna of the at least one first antenna.

Therefore, the user can wirelessly connect the peripheral equipment to the information processing terminal apparatus only by placing the peripheral equipment on the displaying means so that the first and second antennas are opposed to each other.

According to the information processing terminal apparatus of the sixth aspect, in the information processing terminal apparatus according to any one of the first to fourth aspects, the information processing terminal apparatus further includes detection means configured to detect a position of the peripheral equipment, and the control means obtains the position of the peripheral equipment detected by the detection means as the connection position.

Therefore, the control means can obtain the connection position to the peripheral equipment by using detection means such as an image pickup element.

According to the information processing terminal apparatus of the seventh aspect, in the information processing terminal apparatus according to any one of the first to sixth aspects, the control means changes a method for displaying the window in relationship to each of the peripheral equipment based on at least one of types of a plurality of peripheral equipment, connection positions thereof, and connection orders, when the plurality of peripheral equipment is connected to a plurality of predetermined connection positions of the information processing terminal apparatus, respectively.

Therefore, the operability of the peripheral equipment can be improved.

According to the information processing terminal apparatus of the eighth aspect, in the information processing terminal apparatus according to any one of the first to seventh aspects, the control means performs a predetermined process based on at least one of types of a plurality of peripheral equipment, connection positions thereof, and connection orders, when the plurality of peripheral equipment is connected to a plurality of predetermined connection positions of the information processing terminal apparatus, respectively.

Therefore, the operability of the peripheral equipment can be improved.

According to a control method for the information processing terminal apparatus of the ninth aspect, in the control method executed by control means of the information processing terminal apparatus including displaying means configured to display predetermined information, the control method includes the step of controlling the displaying means to display a window displaying in relationship to the peripheral equipment on the displaying means when peripheral equipment is connected to a predetermined connection position of the information processing terminal apparatus.

Therefore, the user can more intuitively operate the peripheral equipment connected to the information processing terminal apparatus than that of the prior art.

According to a program of the tenth aspect, the program includes each step of the control method for the information processing terminal apparatus according to the ninth aspect.

Therefore, the user can more intuitively operate the peripheral equipment connected to the information processing terminal apparatus than that of the prior art.

### INDUSTRIAL APPLICABILITY

As described above, when the peripheral equipment is connected to the predetermined connection position to the information processing terminal apparatus, the popup balloon window popping up from the connection position on the displaying means or a position in the proximity thereof is displayed on the displaying means. Therefore, the user can more intuitively operate the peripheral equipment connected to the information processing terminal apparatus than that of the prior art.

### REFERENCE SIGNS LIST

1 Information processing terminal apparatus,
2A, 2B, and 2K Recording medium,
2C and 2D Camera,
2E Speaker,
2F Keyboard,
2G HDMI (Registered Trademark) connector,
2H DSUB connector,
2I Wireless LAN adapter,
2J Printer,
200A to 200K Popup balloon window,
A1 to A11, A21, and A22 Antenna, and
AS1 and AS2 Antenna seal.

1-10. (canceled)

11. An information processing terminal apparatus having a displaying device configured to display predetermined information and a proximity wireless communication device, the information processing terminal apparatus comprising:
a controller configured to control the displaying device to display a window displaying in relationship to the peripheral equipment at a position where peripheral equipment is located on the displaying device when the peripheral equipment located on the displaying device is connected to a predetermined connection position of the information processing terminal apparatus by performing a proximity wireless communication.

12. The information processing terminal apparatus as claimed in claim 11,
wherein the window is popup-displayed from the connection position on the displaying device or a position in the proximity thereof.

13. The information processing terminal apparatus as claimed in claim 11,
wherein the information processing terminal apparatus further comprises at least one first antenna formed of a transparent conductive film on a front surface of the displaying device,
wherein the peripheral equipment comprises a second antenna, and
wherein the control device obtains the position of the one antenna as the connection position when the peripheral equipment is proximity wirelessly connected to the information processing terminal apparatus with the second antenna opposed to one antenna of the at least one first antenna.

14. The information processing terminal apparatus as claimed in claim 11,
wherein the controller displays information on data stored in the peripheral equipment, an operating state of the peripheral equipment, and input data from the peripheral equipment, or an operation interface to the peripheral equipment within the window.

15. The information processing terminal apparatus as claimed in claim 11,
wherein the controller changes a method for displaying the window in relationship to each of the peripheral equipment based on at least one of types of a plurality of peripheral equipment, connection positions thereof, and connection orders, when the plurality of peripheral equipment is connected to a plurality of predetermined connection positions of the information processing terminal apparatus, respectively.

16. The information processing terminal apparatus as claimed in claim 11,
wherein the controller performs a predetermined process based on at least one of types of a plurality of peripheral equipment, connection positions thereof, and connection orders, when the plurality of peripheral equipment is connected to a plurality of predetermined connection positions of the information processing terminal apparatus, respectively.

17. The information processing terminal apparatus as claimed in claim 11,
wherein the window is displayed so as to partially overlap the peripheral equipment or so as to be in contact with the peripheral equipment.

18. An control method for an information processing terminal apparatus, executed by a controller of the information processing terminal apparatus comprising a displaying device configured to display predetermined information and a proximity wireless communication device, the control method including the step of:
controlling the displaying device to display a window displaying in relationship to the peripheral equipment at a position where peripheral equipment is located on the displaying device when the peripheral equipment located on the displaying device is connected to a predetermined connection position of the information processing terminal apparatus by performing a proximity wireless communication.

19. A program including each step of the control method for the information processing terminal apparatus as claimed in claim 18.
